(19) United States
(12) Patent Application Publication
(10) Pub. No.: US 2024/0428177 A1
(43) Pub. Date: Dec. 26, 2024

(54) SYSTEM AND METHOD FOR TRACKING SHIPMENTS

(71) Applicant: HERE Global B.V., Eindhoven (NL)

(72) Inventor: Basel HASHISHO, Berlin (DE)

(21) Appl. No.: 18/213,574

(22) Filed: Jun. 23, 2023

(51) Int. Cl. G06Q 10/0833; G06Q 10/0835

(52) U.S. Cl. CPC G06Q 10/0833; G06Q 10/08355

(57) ABSTRACT

An approach is provided for tracking a shipment. The approach involves obtaining an optimal route between an origin location and a destination location of the shipment when the shipment is present at the origin location. The approach further involves periodically receiving a list of anonymized vehicle identifiers (IDs) associated with a set of vehicles present in a predefined area of the origin location. The approach further involves calculating a shipment correspondence probability for each one or more vehicles of the set of vehicles based on divergence of a travelled route of a respective vehicle of the one or more vehicles from the optimal route. The approach further involves determining a shipment vehicle of the one or more vehicles based on the calculated shipment correspondence probability. The approach further involves providing a notification corresponding to tracking information associated with the shipment vehicle, via a tracking application.

### BACKGROUND

Typically, tracking a vehicle transporting a shipment may require information about a vehicle license number (or similar identifier) of the vehicle. Conventionally, the vehicle license number may be utilized to connect with a telemetry provider of the vehicle, periodically retrieving position information of the vehicle to determine a live location of the shipment, and further calculate a route to a destination location of the shipment to determine an estimated time of arrival of the shipment.

However, in many cases, the vehicle designated to transport the shipment may be unknown. Furthermore, the information about the vehicle license number may be difficult to retrieve from a telematics provider that updates the position information of the vehicle, by a shipper or tracking party. For example, the information about the vehicle license number may be required before the transport begins to create a monitoring order on a telematics provider platform and to obtain a carrier's (vehicle owner's) consent to track the vehicle during a transport period. A drawback associated with such a method is that knowing the vehicle license plate number by the shipper or tracking party may be challenging since the vehicle license number to be shared with the shipper or tracking party may be considered as a non-essential information by the carrier. Thus, the shipper or tracking party may require explicit carrier consent, and the information about the vehicle license number may not be shared at a correct time needed to enable an effective shipment tracking through the telematics provider platform.

Moreover, the shipment may be connected with an online-connected geographical coordinates tracker that may periodically report the live location of the shipment to the shipper or tracking party. A few drawbacks of such a method may be that such geographical coordinates trackers may be expensive to connect with each shipment. Further, the geographical coordinates tracker may be ineffective in case the shipment is enclosed within a metallic container in the vehicle that may block communications signals required to update the live location of the shipment. Furthermore, a management of the geographical coordinates tracker may be complex.

Thus, there is a need for a system and a method that overcomes the challenges of the conventional systems and provides effective tracking of the shipments.

### Some Example Embodiments

According to one embodiment, a system for tracking a shipment is provided. The system comprises at least one processor, and at least one memory including computer program code for one or more computer programs, the at least one memory and the computer program code configured to, with the at least one processor, cause, at least in part, the system to obtain an optimal route between an origin location and a destination location of the shipment. The optimal route is obtained when the shipment is present at the origin location. The system is also caused to periodically receive a list of anonymized vehicle identifiers (IDs) associated with a set of vehicles present in a predefined area of the origin location of the shipment. The list of the anonymized vehicle IDs is received based on a time window of departure of the shipment from the origin location. The system is further caused to calculate a shipment correspondence probability for each one or more vehicles of the set of vehicles based on divergence of a travelled route of a respective vehicle of the one or more vehicles from the optimal route. The system is further used to determine a shipment vehicle of the one or more vehicles based on the calculated shipment correspondence probability. The system is further caused to provide a notification corresponding to tracking information associated with the shipment vehicle, via a tracking application.

According to another embodiment, a method for tracking a shipment is provided. The method comprises obtaining an optimal route between an origin location and a destination location of the shipment. The optimal route is obtained when the shipment is present at the origin location. The method further comprises periodically receiving a list of anonymized vehicle identifiers (IDs) associated with a set of vehicles present in a predefined area of the origin location of the shipment. The list of the anonymized vehicle IDs is received based on a time window of departure of the shipment from the origin location. The method further comprises calculating a shipment correspondence probability for each one or more vehicles of the set of vehicles based on divergence of a travelled route of a respective vehicle of the one or more vehicles from the optimal route. The method further comprises determining a shipment vehicle of the one or more vehicles based on the calculated shipment correspondence probability. The method further comprises providing a notification corresponding to tracking information associated with the shipment vehicle, via a tracking application.

According to another embodiment, a non-transitory computer-readable storage medium carries one or more sequences of one or more instructions which, when executed by one or more processors, cause, at least in part, an apparatus to perform operations. The operations comprise obtaining an optimal route between an origin location and a destination location of the shipment. The optimal route is obtained when the shipment is present at the origin location. The operations further comprise periodically receiving a list of anonymized vehicle identifiers (IDs) associated with a set of vehicles present in a predefined area of the origin location of the shipment. The list of the anonymized vehicle IDs is received based on a time window of departure of the shipment from the origin location. The operations further comprise calculating a shipment correspondence probability for each one or more vehicles of the set of vehicles based on divergence of a travelled route of a respective vehicle of the one or more vehicles from the optimal route. The operations further comprise determining a shipment vehicle of the one or more vehicles based on the calculated shipment correspondence probability. The operations further comprise providing a notification corresponding to tracking information associated with the shipment vehicle, via a tracking application.

In addition, for various example embodiments described herein, the following is applicable: a computer program product may be provided. For example, a computer program product comprising instructions which, when executed by a computer, cause the computer to perform any one or any combination of methods, operations, or processes disclosed herein.

According to another embodiment, an apparatus comprises means for obtaining an optimal route between an origin location and a destination location of the shipment. The optimal route is obtained when the shipment is present at the origin location. The apparatus further comprises means for periodically receiving a list of anonymized vehicle identifiers (IDs) associated with a set of vehicles present in a predefined area of the origin location of the shipment. The list of the anonymized vehicle IDs is received based on a time window of departure of the shipment from the origin location. The apparatus further comprises means for calculating a shipment correspondence probability for each one or more vehicles of the set of vehicles based on divergence of a travelled route of a respective vehicle of the one or more vehicles from the optimal route. The shipment correspondence probability indicates a possibility of the respective vehicle carrying the shipment. The apparatus further comprises means for determining a vehicle of the one or more vehicles based on the calculated average probability. The determined vehicle has a highest likelihood of carrying the shipment amongst likelihoods of carrying the shipment of the one or more vehicles. The apparatus further comprises means for rendering tracking information associated with the vehicle on a user interface.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of the claims.

Still other aspects, features, and advantages of the invention are readily apparent from the following detailed description, simply by illustrating a number of particular embodiments and implementations, including the best mode contemplated for conducting the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of tracking a shipment, according to one embodiment;

FIG. 2 is a diagram of components of a mapping platform of the system capable of tracking the shipment, according to one embodiment;

FIG. 3 is a diagram of a method depicting exemplary operational steps for tracking the shipment, according to one embodiment;

FIG. 4 is a schematic diagram depicting generation of routing calls for tracking the shipment, according to one embodiment;

FIG. 5 is a schematic diagram depicting distribution of a linear probability calculated for tracking the shipment, according to one embodiment;

FIG. 6A and FIG. 6B collectively depict schematic diagrams for updating shipment correspondence probability of one or more vehicles based on divergence of a travelled route from an optimal route, according to one embodiment;

FIG. 7 is a diagram depicting a data structure that includes information of monitored one or more vehicles for tracking the shipment, according to one embodiment;

FIG. 8 is a diagram depicting a user interface with rendered shipment information and tracking information, according to one embodiment;

FIG. 9 is a flowchart of a method for tracking the shipment, according to one embodiment;

FIG. 10 is a diagram of a geographic database, according to one embodiment;

FIG. 11 is a diagram of hardware that can be used to implement an embodiment;

FIG. 12 is a diagram of a chip set that can be used to implement an embodiment; and

FIG. 13 is a diagram of a mobile terminal (e.g., handset, vehicle, or part thereof) that can be used to implement an embodiment.

### DESCRIPTION OF SOME EMBODIMENTS

Examples of a system, method, and computer program for tracking of the shipment are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

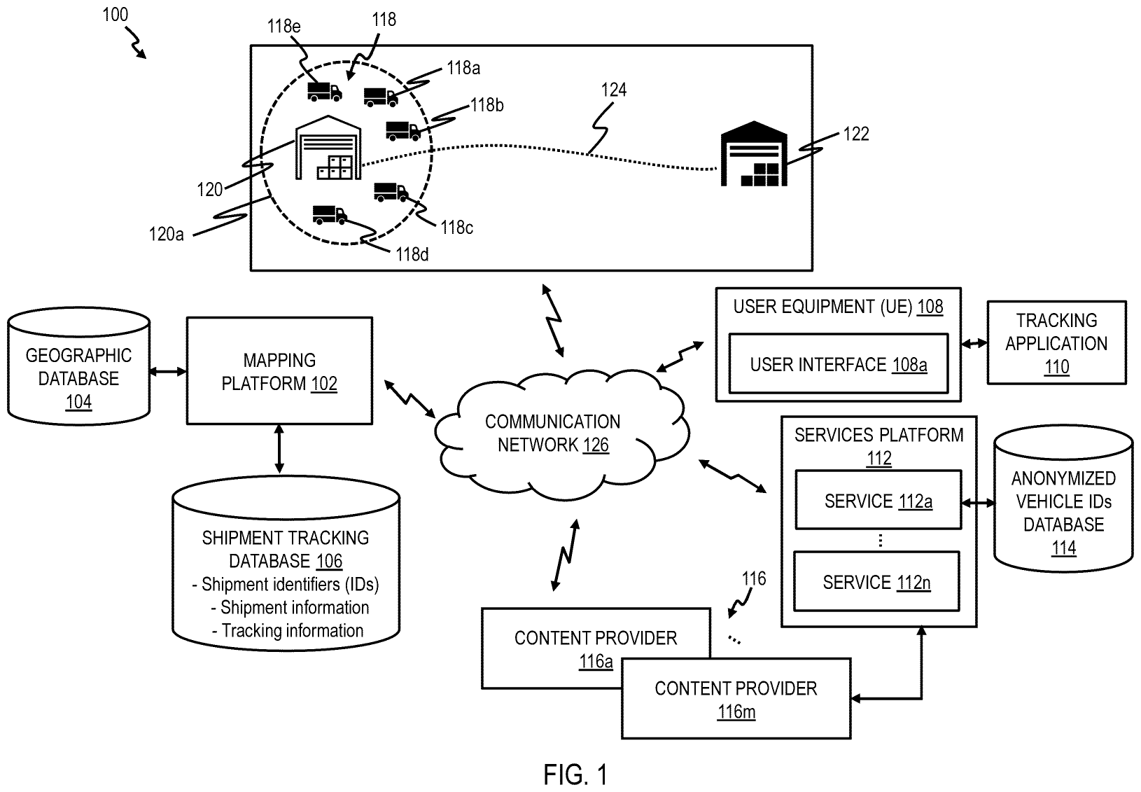

FIG. 1 is a diagram of a system 100 capable of tracking a shipment, according to one embodiment. The system 100 may include a mapping platform 102. The mapping platform 102 may be associated with a geographic database 104 and a shipment tracking database 106. The system 100 may further include a user equipment (UE) 108. The UE 108 may include a user interface 108a. The UE 108 may be associated with a tracking application 110. The system 100 may further include a services platform 112. The services platform 112 may be associated with various services, such as a service 112a and a service 112n. The services platform 112 may be associated with an anonymized vehicle identifiers (IDs) database 114. The system 100 may further include content providers 116, such as a content providers 116a and a content providers 116m. The system 100 may further include a set of vehicles 118, such as a first vehicle 118a, a second vehicle 118b, a third vehicle 118c, a fourth vehicle 118d and a fifth vehicle 118e. The shipment may be carried in any one vehicle of the set of vehicles 118. The system 100 may further include information about an origin location 120 and a destination location 122 of the shipment. The origin location 120 may have a predefined area 120a. The system 100 may further include information about an optimal route 124 to transport the shipment. The mapping platform 102, the UE 108, the services platform 112, the content providers 116 and the set of vehicles 118 may communicate via a communication network 126.

Conventionally, methods of tracking the shipment may require information about a vehicle license number of a vehicle. carrying the shipment. The vehicle license number may be utilized to track the vehicle to determine a live or a current location of the shipment. However, the vehicle transporting the shipment may be unknown. Furthermore, information about the vehicle license number may be difficult to retrieve from a telematics provider. For example, a consent of a carrier, such as a vehicle owner may be required by the telematics provider to share the vehicle license number with a shipper or tracking party. Moreover, in some cases, to track the shipment, the shipment may be connected with an online-connected geographical coordinates tracker, such as a global positioning system (GPS) tracker. However, the GPS tracker may be expensive to connect with each shipment. Furthermore, the GPS tracker may be ineffective in case the shipment is enclosed within a metallic container in the vehicle that may block communications signals required to update the live location of the shipment.

On the other hand, the proposed system 100 provides a probabilistic tracking approach that may overcome the drawbacks of the conventional methods. The system 100 may be configured to anonymously track the set of vehicles 118 to track the shipment. For example, one vehicle (such as a shipment vehicle) of the set of vehicles 118 may be carrying the shipment. However, the system 100 may track each of the set of vehicles 118 that has a likelihood of carrying the vehicle, to probabilistically determine the shipment vehicle that may actually be carrying the shipment. Furthermore, due to privacy constraints, the system 100 may track the set of vehicles 118 based on an anonymized vehicle identifier (ID) associated with each of the set of vehicles 118, instead of the vehicle license number of each of the set of vehicles 118. Thus, the consent of the vehicle owners may no longer be required to track the set of vehicles 118. In such a manner, the privacy of drivers of the set of vehicles 118 may be maintained. As one or more vehicles of the set of vehicles 118 starts travelling from the origin location 120, a shipment correspondence probability for the one or more vehicles is calculated. The shipment correspondence probability is calculated based on divergence of a travelled route of a respective vehicle of the one or more vehicles from the optimal route 124. Thus, at the end, the shipment vehicle of the one or more vehicles is determined with a definite probability that is carrying the shipment towards the destination location 122. In such a manner, the definite shipment vehicle carrying the shipment may be determined. The system 100 may thus eliminate the usage of a GPS tracker on each shipment, thereby reducing the overall cost for the tracking of the shipments. Moreover, as the need of the GPS tracker is eliminated, the need of managing such GPS tracker is also eliminated. Therefore, the system 100 provides an effective solution for tracking the shipments.

In operation, the shipment may need to be tracked. For example, a user such as a customer who may have ordered the shipment may require tracking the shipment. In another example, a shipping provider who may ship the shipment to the customer may need to track the shipment. Typically, the shipment may be associated with a shipment identifier (ID). Moreover, shipment information may be linked with the shipment ID. In some embodiments, the shipment information may include information of the origin location 120, the destination location 122, and a time window of departure of the shipment from the origin location 120.

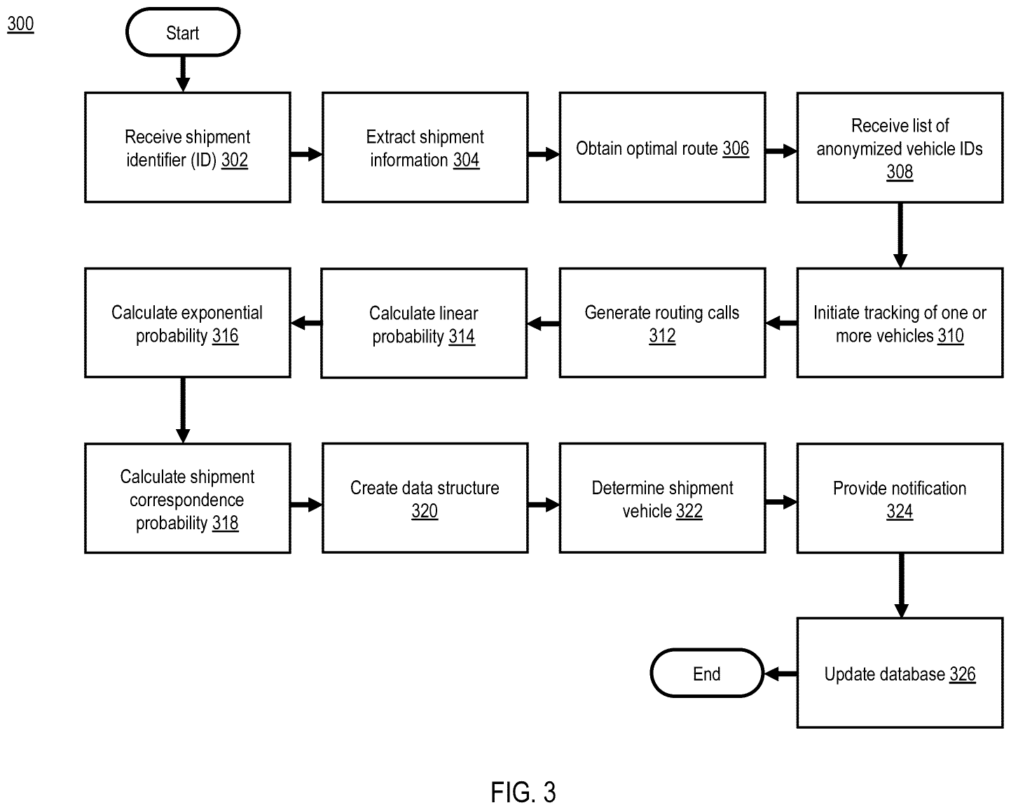

The time window of departure may indicate the time at which the shipment may be present at the origin location 120 and may depart from the origin location 120. At commencement of the time window of departure of the shipment, the mapping platform 102 may receive the shipment ID and the associated shipment information from the shipment tracking database 106. Furthermore, based on the determination that the shipment is present at the origin location 120, the mapping platform 102 may obtain the information about the optimal route 124 between the origin location 120 and the destination location 122 from a memory associated with the mapping platform 102. Details of obtaining the information about the optimal route 124 are further provided, for example, in FIG. 3.

Furthermore, based on the time window of departure of the shipment, the mapping platform 102 may be configured to periodically receive a list of anonymized vehicle identifiers (IDs) associated with the set of vehicles 118 present in the predefined area 120a of the origin location 120 of the shipment. In an embodiment, the mapping platform 102 may receive the list of anonymized vehicle IDs from the anonymized vehicle IDs database of the services platform 112. For example, the service 112a may be associated with a telematics platform that may be configured to record positional information such as current geographical coordinates of the set of vehicles 118. The service 112a may further generate the list of anonymized vehicle IDs for each of the set of vehicles 118. In some embodiments, the mapping platform 102 may further receive the current geographical coordinates of the set of vehicles 118 from the services platform 112. Details of the reception of the list of anonymized vehicle IDs and the current geographical coordinates are further provided, for example, in FIG. 3.

The mapping platform 102 may further initiate tracking of one or more vehicles of the set of vehicles 118 based on the current geographical coordinates of the one or more vehicles. For example, during the time window of departure of the shipment, the one or more vehicles, such as the first vehicle 118a, the second vehicle 118b, the third vehicle 118c and the fourth vehicle 118d may depart, and the fifth vehicle 118e may still be at or near the origin location 120. In such a case, the mapping platform 102 may track the one or more vehicles that actually departed from the origin location 120 during the time window of departure of the shipment. The fifth vehicle 118e may be considered a vehicle that may definitely not be carrying the shipment. In some embodiments, the mapping platform 102 may initiate tracking of the one or more vehicles based on the current geographical coordinates of the one or more vehicles. Details of the tracking of the one or more vehicles are further provided, for example, in FIG. 3.

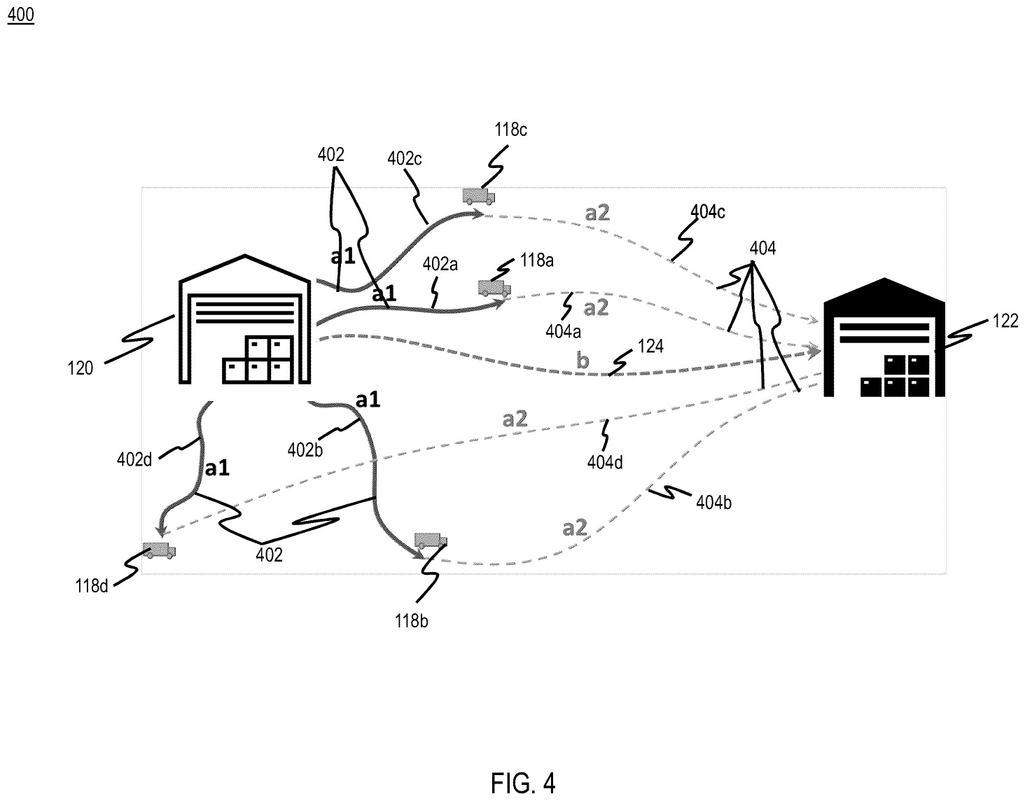

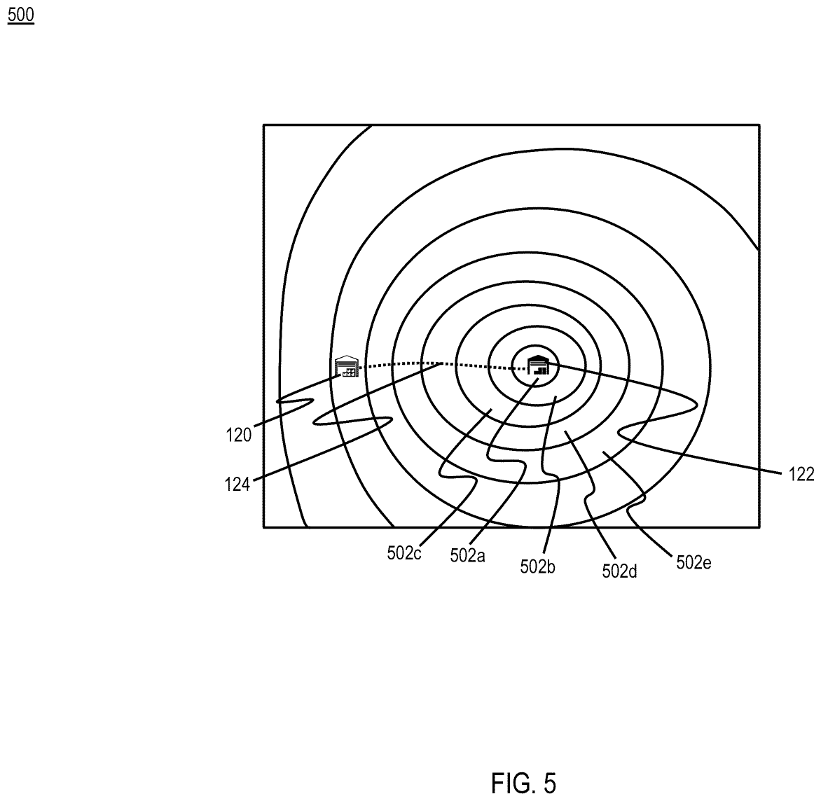

The mapping platform 102 may be further configured to calculate the shipment correspondence probability for each one or more vehicles, such as the first vehicle 118a, the second vehicle 118b, the third vehicle 118c and the fourth vehicle 118d based on divergence of a travelled route of a respective vehicle of the one or more vehicles from the optimal route 124. The shipment correspondence probability may indicate a possibility of the respective vehicle carrying the shipment. For example, the shipment correspondence probability of a vehicle of the one or more vehicles for which the travelled route is or near the optimal route 124 may be higher than the shipment correspondence probability of a vehicle of the one or more vehicles for which the travelled route is away from the optimal route 124. Thus, based on the travelled route of the one or more vehicles, the mapping platform 102 may identify the vehicles of the one or more vehicles that may be travelling towards the destination location 122, and may calculate the shipment correspondence probability of carrying the shipment for each vehicle. The more the vehicle follows the optimal route 124, higher may be the value of the shipment correspondence probability for the vehicle. Details of the calculation of the shipment correspondence probability are further provided, for example, in FIG. 3, FIG. 4 and FIG. 5.

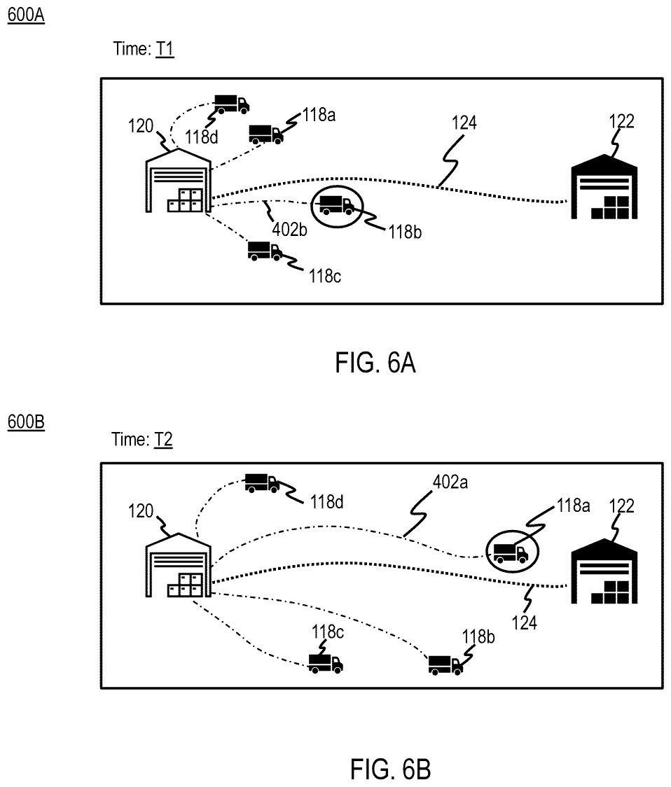

Based on the calculated shipment correspondence probability, the mapping platform 102 may be further configured to determine a shipment vehicle of the one or more vehicles that may be carrying the shipment. For example, during a time period “T=0 to T1”, the shipment correspondence probability of the second vehicle 118b may be highest, e.g., the shipment correspondence probability may be 0.56. Thus, during the time period “T=0 to T1”, the second vehicle 118b may be considered to be most likely carrying the shipment. After a time instance “T=T2”, the shipment correspondence probability of the first vehicle 118a may be highest and more than or equal to a threshold. For example, the threshold may be 0.8, and the shipment correspondence probability of the first vehicle 118a may be 0.92 after the time instance “T=T2”. Thus, after the time instance “T=T2”, the first vehicle 118a may be considered to be most likely carrying the shipment. Once the shipment correspondence probability of any of the vehicle is calculated to be more than or equal to the threshold, the mapping platform 102 may determine the vehicle (such as the first vehicle 118a) to most definitely be carrying the shipment and may update the shipment correspondence probability of the shipment vehicle, such as the first vehicle 118a to the value 1. Thus, with such a probabilistic approach, the system 102 may enable tracking of the shipment. Details of the determination of the shipment vehicle carrying the shipment are further provided, for example, in FIG. 3, FIG. 6A and FIG. 6B.

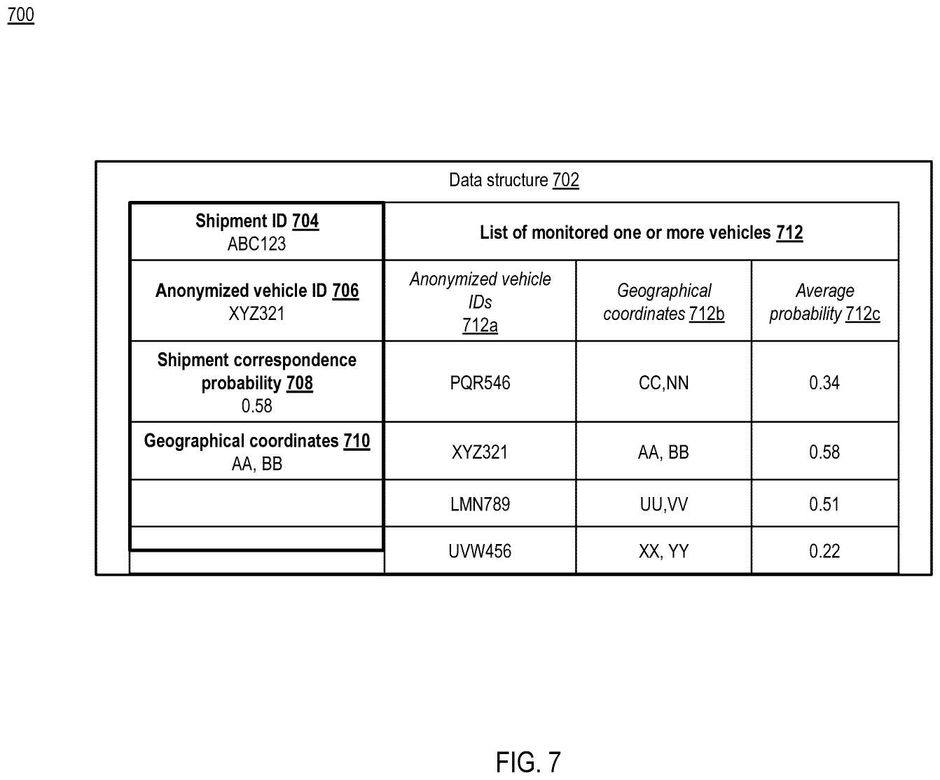

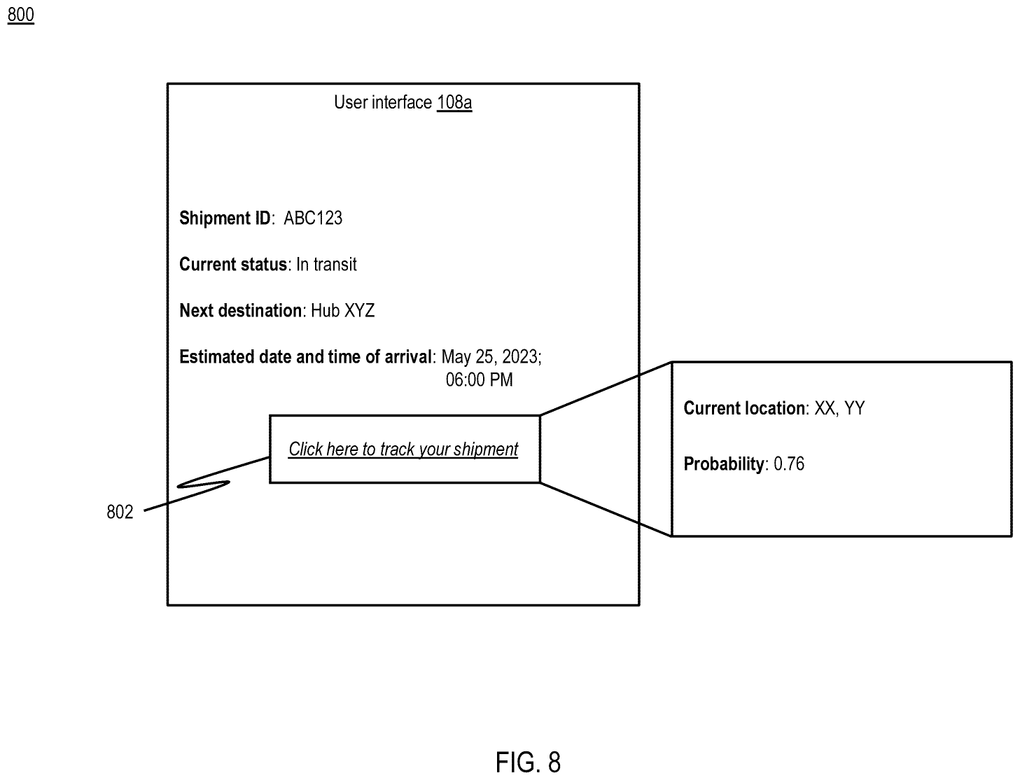

The mapping platform 102 may further be configured to provide a notification corresponding to tracking information associated with the shipment vehicle, via a tracking application. In some embodiments, the tracking application may be associated with a mapping application installed on the UE 108 and may be configured to provide route updates of the shipment. For example, the notification may be provided via a map rendered on the tracking application. In another example, the tracking information associated with the vehicle may be rendered on the user interface 108a. For example, for the time period “T=0 to T1”, the tracking information associated with the second vehicle 118b may be rendered. Further, after the time instance “T=T2”, the tracking information associated with the first vehicle 118a may be rendered on the user interface 108a. The UE 108 may be associated with any of the customer of the shipment or the shipping provider. In some embodiments, the mapping platform 102 may create a data structure corresponding to the shipment information of the shipment and the tracking information of the one or more vehicles. The data structure may further be utilized to provide the notification or render the tracking information. Details of providing the notification, rendering of the tracking information and the data structure are further provided, for example, in FIG. 3, FIG. 7 and FIG. 8.

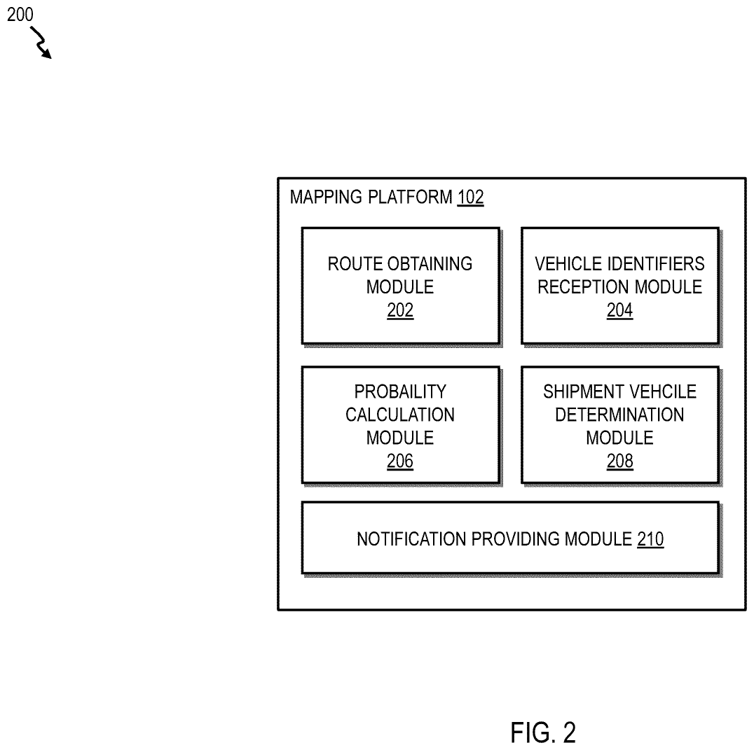

The components of the mapping platform 102 for tracking the shipment are described in FIG. 2.

FIG. 2 is a diagram of components of the mapping platform 102 capable of tracking the shipment, according to one embodiment. In one embodiment, as shown in FIG. 2, the mapping platform 102 of the system 100 includes one or more components for tracking the shipment according to the various embodiments described herein. It is contemplated that the functions of the components of the mapping platform 102 may be combined or performed by other components of equivalent functionality. As shown, in one embodiment, the mapping platform 102 includes a route obtaining module 202, a vehicle identifiers reception module 204, a probability calculation module 206, a shipment vehicle determination module 208 and a notification providing module 210.

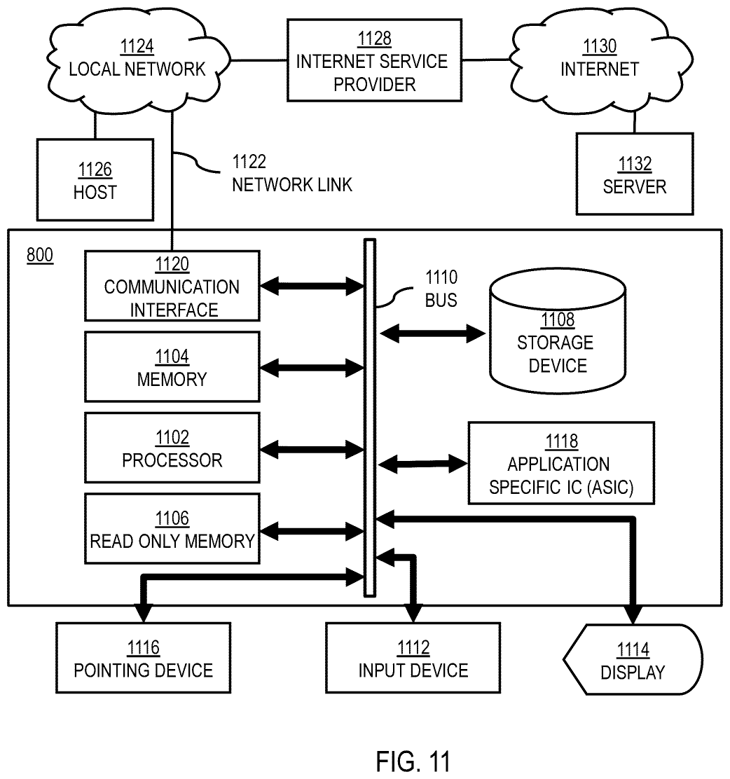

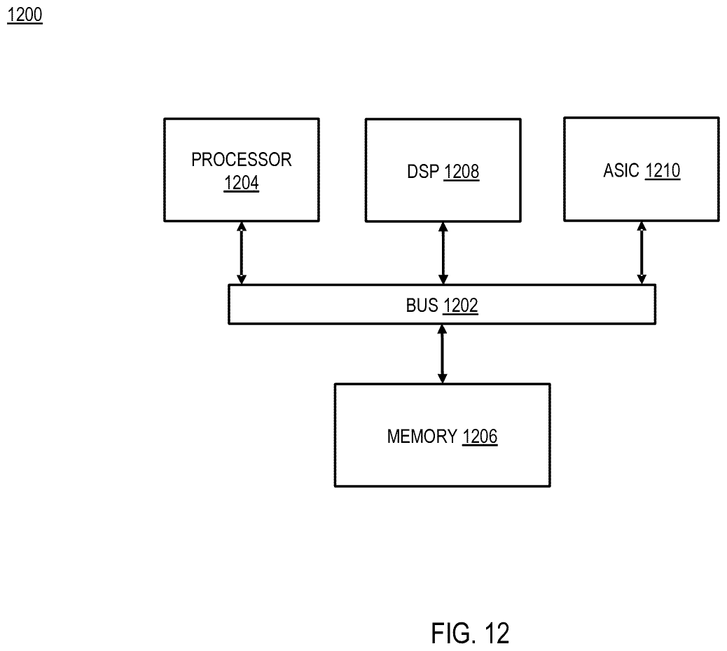

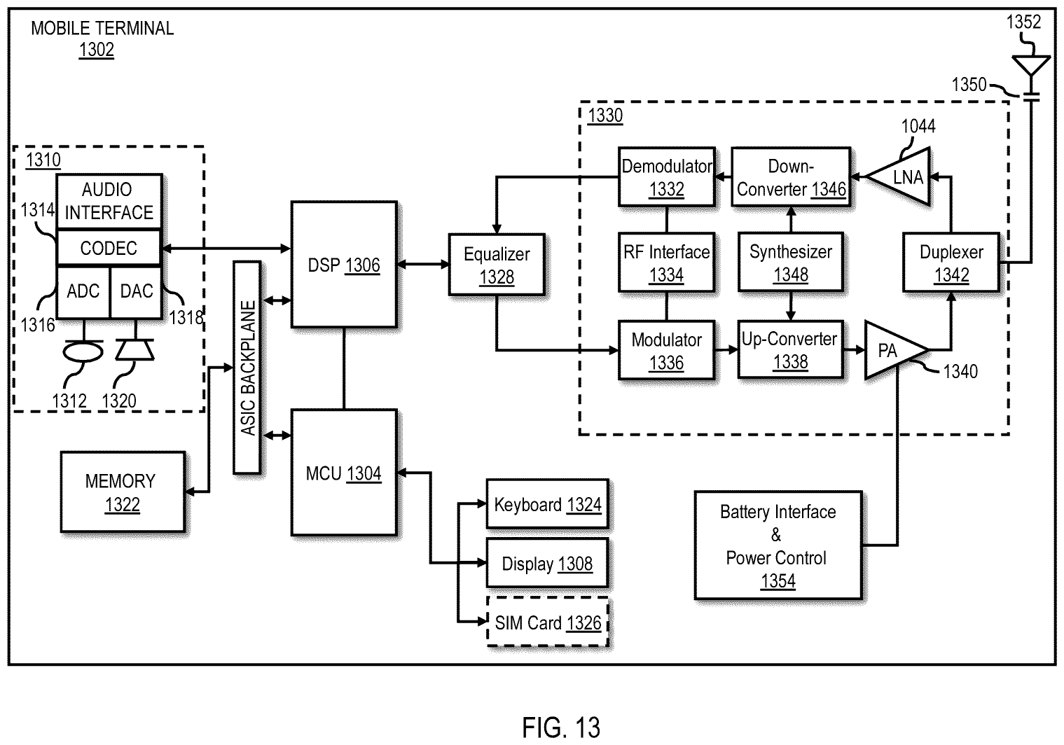

The route obtaining module 202 may be configured to obtain the optimal route 124 using map data from the geographic database 104. For example, route obtaining module 202 may calculate the optimal route 124 using e.g., a routing engine implementing a route/path finding algorithm such as Dijkstra, A*, RIPA, etc. The route obtaining module may further use road traffic/road event information to perform the calculation of the optimal route 124. The calculated route may be made accessible by the route obtaining module 202 via a memory (for example, a memory shown in FIG. 11, FIG. 12 or FIG. 13) to other entities of the system 100. The vehicle identifiers reception module 204 may be configured to receive the list of anonymized vehicle IDs of the set of vehicles 118 from the telematics platform. The probability calculation module 206 may be configured to calculate the shipment correspondence probability for each of the one or more vehicles of the set of vehicles 118. The shipment vehicle determination module 208 may be configured to determine the shipment vehicle that has the highest likelihood of carrying the shipment. The notification providing module 210 may be configured to provide the notification corresponding to the tracking information associated with the shipment vehicle via the tracking application.

The above presented modules and components of the mapping platform 102 can be implemented in hardware, firmware, software, or a combination thereof. Though depicted as a separate entity in FIG. 1, it is contemplated that the mapping platform 102 may be implemented as a module of any of the components of the system 100 (e.g., a component of the services platform 112, the content providers 116, the UE 108, the tracking application 110, and/or the like). In another embodiment, one or more of the modules 202-210 may be implemented as a cloud-based service, local service, native application, or combination thereof. The functions of the mapping platform 102 and modules 202-210 are discussed with respect to the figures below.

FIG. 3 is a diagram 300 of a method depicting exemplary operational steps for tracking the shipment, according to one embodiment. In various embodiments, the mapping platform 102 and/or any of the modules 202-210 may perform one or more portions of the method and may be implemented in, for instance, a chip set including a processor and a memory as shown in FIG. 11 and FIG. 12. As such, the mapping platform 102 and/or any of the modules 202-210 may provide means for accomplishing various parts of the method, as well as means for accomplishing embodiments of other processes described herein in conjunction with other components of the system 100. Although the method is illustrated and described as a sequence of steps, it is contemplated that various embodiments of the method may be performed in any order or combination and need not include all of the illustrated steps.

At step 302, the shipment ID of the shipment may be received. In some embodiments, the mapping platform 102 may be configured to receive the shipment ID of the shipment from the shipment tracking database 106. In an example, a service, such as the service 112n of the services platform 112 may be associated with a shipping provider that may be responsible to transport the shipment from the origin location 120 to the destination location 122. The shipment ID of the shipment may be generated by the service 112n and may be transmitted to the mapping platform 102.

In an exemplary scenario, the shipment may be present at the origin location 120. In an embodiment, the shipment may be present in any of the set of vehicles 118. The shipment vehicle of the set of vehicles 118 actually carrying the shipment may be unknown to the mapping platform 102 at the time of reception of the shipment ID. The shipment ID may be received for example, before the commencement of the time window of departure of the shipment. For example, the time window of departure of the shipment may be 02:00 post meridiem (PM) to 03:00 PM. Thus, the shipment may be present at the origin location 120 at any time around 02:00 PM and 03:00 PM for the departure. The mapping platform 102 may receive the shipment ID for example, at some time before 02:00 PM, such as to track any vehicle that may depart from the origin location 120 around or between 02:00 PM and 03:00 PM. For example, the mapping platform 102 may receive the shipment ID at 01:45 PM. In an embodiment, the shipment ID may be a unique string of alphanumeric characters assigned to the shipment.

At step 304, the shipment information may be extracted. In some embodiments, the mapping platform 102 may be configured to extract the shipment information linked with the received shipment ID. The shipment information may include information about at least one of the origin location 120, the destination location 122, and the time window of departure of the shipment from the origin location 120. For example, shipment information may include the geographical coordinates of the origin location 120 and the destination location 122. In an example, the origin location 120 and the destination location 122 may be for example, warehouses or intermediate hubs where the shipment may be stored for further transportation. The shipment information may include the information of each stop or location that may be used to store the shipment. The shipment information may also include the time window of departure of the shipment from each of the stop or location that may be used to store the shipment.

In some embodiments, the shipment information may be generated by a service of the services platform 112. The generated shipment information may be linked with the shipment ID of the shipment. Once the shipment ID is received by the mapping platform 102, the linked shipment information may be extracted by the mapping platform 102. The mapping platform 102 may further be configured to store the shipment ID and the linked shipment information in the shipment tracking database 106.

At step 306, the information about the optimal route 124 may be obtained. The mapping platform 102 may be configured to obtain the information about the optimal route 124 between the origin location 120 and the destination location 122 of the shipment. In some embodiments, the route obtaining module 202 of the mapping platform 102 may be configured to obtain the information about the optimal route 124. Once the shipment ID is received and the shipment information is extracted, the mapping platform 102 may obtain the information about the optimal route 124. The optimal route 124 may be for example, a preferred route or a shortest route between the origin location 120 and the destination location 122. The optimal route 124 may be determined based on several factors, such as a time of a day, traffic conditions, construction works between the origin location 120 and the destination location 122, and the like.

In some embodiments, the mapping platform 102 may be configured to determine the optimal route 124 between the origin location 120 and the destination location 122 and store in the memory associated with the mapping platform 102. The mapping platform 102 may obtain the information about the optimal route 124 from the memory after reception of the shipment information.

In one or more embodiments, the mapping platform 102 may be configured to determine the optimal route 124 between the origin location 120 and the destination location 122 in real-time or near real-time. For example, based on the time window of the departure included in the shipment information, the mapping platform 102 may determine the optimal route 124. In an exemplary scenario, the time window of the departure may be 02:00 PM to 03:00 PM. The mapping platform 102 may determine the optimal route 124 between the origin location 120 and the destination location 122 for the time window of 02:00 PM to 03:00 PM. The determined optimal route 124 may be stored in the memory associated with the mapping platform 102.

At step 308, the list of anonymized vehicle IDs may be received. The mapping platform 102 may be configured to periodically receive the list of anonymized vehicle IDs associated with the set of vehicles 118 present in the predefined area 120a of the origin location 120. In some embodiments, the vehicle identifiers reception module 204 may be configured to periodically receive the list of anonymized vehicle IDs. Each of the anonymized vehicle ID may be for example, a unique string of alphanumeric characters assigned to a vehicle of the set of vehicles 118.

Further, the predefined area 120a may be for example, an area surrounding the origin location 120 in which the set of vehicles 118 may be present. For example, the predefined area 120a may be an area having a radius of a few meters or kilometers around the origin location 120. In an example, there may be a parking area near the origin location 120. In such a case, the parking area may be included in the predefined area 120a of the origin location 120.

In an embodiment, the list of anonymized vehicle IDs may be generated to eliminate a need to record vehicle license numbers of the set of vehicles 118 as recording the vehicle license numbers may require consent of vehicle drivers/owners. In an exemplary scenario, the service 122a of the services platform 122 may be associated with a telematics platform. The telematics platform may be configured to record the information associated with the set of vehicles 118, such as current geographical coordinates of the set of vehicles 118, and a timestamp associated with the set of vehicles 118. The telematics platform may be utilized by the mapping platform 102 for receiving the information of the set of vehicles 118. In order to store the information associated with the set of vehicles 118, instead of using the vehicle license numbers, the telematics platform may generate an anonymized vehicle ID of the list of anonymized vehicle IDs for each of the set of vehicles 118. The generated list of anonymized vehicle IDs may be transmitted to the mapping platform 102.

In an embodiment, the list of the anonymized vehicle IDs may be received by the mapping platform 102 based on the time window of departure of the shipment from the origin location 120. For example, the anonymized vehicle ID of any vehicle that may be present in the predefined area 120a of the origin location 120 at the time window of departure of the shipment, such as the time window of 02:00 PM to 03:00 PM, may be received by the mapping platform 102. Thus, the list of the anonymized vehicle IDs of the set of vehicles 118 present in the predefined area 120a of the origin location 120 at the time window of departure of the shipment may be received.

In some embodiments, the list of anonymized vehicle IDs may be received periodically for a first time period associated with the time window of departure of the shipment. In some embodiments, the shipment may depart some time before commencement of the time window of departure from the origin location 120. In other embodiments, the shipment may depart sometime later after an end of the time window of departure from the origin location 120. Thus, the mapping platform 102 may consider the first time period that includes a time buffer around the time window of departure of the shipment. In an exemplary scenario, the time window of departure may be 02:00 PM to 03:00 PM. The mapping platform 102 may further consider a time buffer, such as 30 minutes before and after the time window of departure to receive the list of anonymized vehicle IDs. For example, the list of anonymized vehicle IDs may be received from 01:30 PM till 03:30 PM. In such a case, the first time period may be 01:30 PM till 03:30 PM. In such a manner, the list of anonymized vehicle IDs of each vehicle of the set of vehicles 118 present in the predefined area 120a of the origin location 120 in the first time period may be received.

The mapping platform 102 may receive the list of anonymized vehicle IDs periodically from the telematics platform. For example, the mapping platform 102 may transmit a call to the telematics platform every few minutes in the first time period to receive the list of anonymized vehicle IDs. The period of receiving the list of anonymized vehicle IDs may be configurable, such that no vehicle may leave the origin location 120 without being included in one of periodic calls to receive the list of anonymized vehicle IDs. In an example, the mapping platform 102 may transmit the call to the telematics platform every 5 minutes to receive the list of anonymized vehicle IDs. In such a manner, anonymized vehicle ID of each vehicle of the set of vehicles 118 having a likelihood of carrying the shipment may be received.

At step 310, tracking of one or more vehicles of the set of vehicles 118 may be initiated. In some embodiments, the mapping platform 102 may be configured to initiate the tracking of the one or more vehicles based on periodic reception of current geographical coordinates of the one or more vehicles. For example, the mapping platform 102 may be configured to receive the current geographical coordinates of the set of vehicles 118 in the predefined area 120a along with the list of anonymized vehicle IDs from the telematics platform for the first time period. The current geographical coordinates may include for example, GPS coordinates of the set of vehicles 118. The GPS coordinates of the set of vehicles 118 may be recorded by use of GPS sensors in each of the vehicles of the set of vehicles 118. The telematics platform may record the current GPS coordinates and the timestamp associated therewith. The current geographical coordinates may include, for example, a current latitude and a longitude of each of the set of vehicles 118.

For example, out of the set of vehicles 118, the one or more vehicles may actually depart from the origin location 120 in the first time period. In an exemplary scenario, the one or more vehicles, such as the first vehicle 118a, the second vehicle 118b, the third vehicle 118c and the fourth vehicle 118d may depart from the origin location 120 in the first time period. In such a case, the mapping platform 102 may initiate the tracking of the vehicle 118a, the second vehicle 118b, the third vehicle 118c and the fourth vehicle 118d based on the current geographical coordinates. As the fifth vehicle 118e may not depart in the first time period, the likelihood of the fifth vehicle 118e being the carrier vehicle for the shipment may be considered to be zero. Thus, the tracking of the fifth vehicle 118e may not be initiated.

At step 312, routing calls may be generated. The routing calls may be requests transmitted to the telematics provider to receive information about the one or more vehicles. For example, the mapping platform 102 may transmit the request as the routing call to determine the current geographical coordinates of the one or more vehicles. The routing calls may be generated to determine divergence of a travelled route of the one or more vehicles. In some embodiments, the mapping platform 102 may be configured to determine the divergence of the travelled route of the respective vehicle of the one or more vehicles from the optimal route 124 based on the initiated tracking. The optimal route 124 may be considered the shortest route that may be followed by the one or more vehicles to reach the destination location 122. Thus, in order to determine the shipment vehicle of the one or more vehicles that may be carrying the shipment, the travelled route of each of the one or more vehicles may be tracked. Based on the tracking, mapping platform 102 may determine the divergence of the travelled route of the respective vehicle of the one or more vehicles. Details of the generation of routing calls are further provided, for example, in FIG. 4.

FIG. 4 is a schematic diagram 400 depicting generation of routing calls for tracking the shipment, according to one embodiment. In various embodiments, the mapping platform 102 and/or any of the modules 202-210 may perform one or more portions of the operations depicted in the schematic diagram 400 and may be implemented in, for instance, the chip set including the processor and the memory as shown in FIG. 11 and FIG. 12. The schematic diagram 400 may include the origin location 120, the destination location 122, and the optimal route 124 between the origin location 120 and the destination location 122. The schematic diagram 400 may further include one or more vehicles, such as the first vehicle 118a, the second vehicle 118b, the third vehicle 118c and the fourth vehicle 118d of the set of vehicles 118 that departed in the time window of departure of the shipment. The schematic diagram 400 may further depict a first set of distances 402, such as a first distance 402a, a second distance 402b, a third distance 402c and a fourth distance 402d. The schematic diagram 400 may further depict a second set of distances 404, such as a first distance 404a, a second distance 404b, a third distance 404c and a fourth distance 404d.

In some embodiments, the mapping platform 102 may be configured to generate a first routing call to determine the first set of distances 402. The first routing call may be associated with determination of the first set of distances 402 between one origin to many destinations. The generated first routing call may be transmitted to the telematics platform to determine the first set of distances 402. The first routing call is generated before the shipment reaches the destination location 122. A timestamp of the first routing call may be the beginning or commencement time of the time window of departure of the shipment. The first set of distances 402 may be determined in real-time or near-real time.

Notably, a distance of the first set of distances 402 in the first routing call is determined between the origin location 120 of the shipment and current geographical coordinates of a respective vehicle of the one or more vehicles. For example, the distance 402a may be determined between the origin location 120 and the current geographical coordinates of the first vehicle 118a. The distance 402b may be determined between the origin location 120 and the current geographical coordinates of the second vehicle 118b. The distance 402c may be determined between the origin location 120 and the current geographical coordinates of the third vehicle 118c. Similarly, the distance 402d may be determined between the origin location 120 and the current geographical coordinates of the fourth vehicle 118d.

The first set of distances 402 may be the distances actually travelled by the one or more vehicles on their respective traveled routes after departure from the origin location 120. As only one of the one or more vehicles may be carrying the shipment, and may be headed towards the destination location 122, the traveled routes of the vehicles not carrying the shipment may be different than the optimal route 124. Moreover, the traveled route of the shipment vehicle carrying the shipment may not be same as the optimal route 124 but may be similar to or near the optimal route 124. In such a case, the first set of distances 402 may be utilized to determine an amount of the divergence of the traveled route of the one or more vehicles from the optimal route 124, to determine the shipment vehicle actually carrying the shipment.

In some embodiments, the mapping platform 102 may be configured to generate a second routing call to determine the second set of distances 404. The second routing call may be associated with determination of the second set of distances 404 between many origins to one destination. The generated second routing call may be transmitted to the telematics platform to determine the second set of distances 404. The second routing call is generated before the shipment reaches the destination location 122. A timestamp of the second routing call may be a current timestamp of the second routing call.

Notably, a distance of the second set of distances 404 in the second routing call is determined between the current geographical coordinates of a respective vehicle of the one or more vehicles and the destination location 122 of the shipment. The second routing call may be a many origins to one destination call. For example, the distance 404a may be determined between the current geographical coordinates of the first vehicle 118a and the destination location 122. The distance 404b may be determined between the current geographical coordinates of the second vehicle 118b and the destination location 122. The distance 404c may be determined between the current geographical coordinates of the third vehicle 118c and the destination location 122. Similarly, the distance 404d may be determined between the current geographical coordinates of the fourth vehicle 118d and the destination location 122.

The second set of distances 404 may be the distances required to be travelled by the one or more vehicles to reach the destination location 122. For example, the second set of distances 404 may be leftover distances required to be covered by the respective one or more vehicles to reach the destination location 122. Based on the current geographical coordinates of the one or more vehicles, the second set of distances 404 may be determined in real-time or near-real time. Thus, the mapping platform 102 may be configured to determine the first set of distances 402 and the second set of distances 404 based on the current geographical coordinates of the one or more vehicles in the real-time or near-real time. The determined first set of distances 402 and the second set of distances 404 may be further utilized to calculate a linear probability for each of the one or more vehicles. Details of calculation of the linear probability for each of the one or more vehicles are further provided, for example, in FIG. 3.

Referring again to FIG. 3, at step 314, the linear probability for each of the one or more vehicles may be calculated. The linear probability may be utilized in calculation of the shipment correspondence probability for each of the one or more vehicles. In some embodiments, the mapping platform 102 may be configured to calculate the linear probability associated with each of the one or more vehicles based on the generated first routing call, the generated second routing call and the obtained optimal route 124. For example, the first set of distances 402, the second set of distances 404 and a distance of the optimal route 124 may be utilized to calculate the linear probability.

To calculate the linear probability for each of the one or more vehicles, the mapping platform 102 may determine a first factor and a second factor. The first factor may be used to determine the divergence or closeness of the travelled route plus the route to be followed to reach the destination location 122 by the one or more vehicles, from the optimal route 124. For example, the divergence between the sum of the first set of distances 402 and the second set of distances 403, and the distance of the optimal route 124 may be determined. The likelihood of a vehicle of the one or more vehicles following the optimal route 124 towards the destination location 122 may be directly proportional to the first factor. In an embodiment, the first factor (also denoted as F1) may be represented as:

$$F 1 = b / ( a 1 + a 2 ) \qquad ( 1 )$$

where b is the distance of the optimal route 124, a1 is the first set of distances 402 and a2 is the second set of distances 404.

Thus, for each vehicle, F1 may be determined based on a sum of the distance determined in the first routing call, the distance determined in the second routing call, and the distance of the optimal route 124. In an exemplary scenario, for the first vehicle 118a, the first distance 402a determined in the first routing call may be 1.4 kilometers (km). The first distance 404a determined in the second routing call may be 2.6 km, and the distance of the optimal route 124 may be 3.5 km. In such a case, the F1 for the first vehicle 118a may be “F1=(3.5)/(1.4+2.6)”.

In another exemplary scenario, for the second vehicle 118b, the first distance 402b determined in the first routing call may be 1.7 kilometers (km). The first distance 404b determined in the second routing call may be 3.1 km, and the distance of the optimal route 124 may be 3.5 km. In such a case, the F1 for the second vehicle 118b may be “F1=(3.5)/(1.7+3.1)”. Similarly, for each of the one or more vehicles, the first factor “F1” may be determined.

To calculate the linear probability for each of the one or more vehicles, the mapping platform 102 may further determine the second factor. Notably, for vehicles that may be very near the origin location 120, F1 may mostly be dominated by “a2” and that may be similar to the distance “b” of the optimal route 124 when “a1” distances are short. Such a difference in the distances may provide a false high probability of the vehicle being on the optimal route 124. For such a reason, the second factor (also represented as F2) is introduced for balancing when the vehicle is still too close to the origin location 120.

The second factor may be utilized to determine a progress of travel of the one or more vehicles on the optimal route 124 as a percentage of the overall distance “b” of the optimal route 124. However, it may be noted that utilizing “a1” as a value of the progressed travel of the one or more vehicles would be inaccurate as in such a case, it needs to be assumed that the one or more vehicles are actually travelling on the optimal route 124. Therefore, to determine the progress of travel of the one or more vehicles, a difference between the current geographical coordinates of the one or more vehicles and the distance “b” of the optimal route 124 may be considered, i.e., “b-a2”. It may be noted that such condition may result in negative values if “a2” is already longer than “b”, however, the negative values may be acceptable for ranking of the probabilities of the one or more vehicles.

The second factor F2 may be represented as:

$$F 2 = ( b - a 2 ) / b \qquad ( 2 )$$

In some embodiments, the linear probability associated with each of the one or more vehicles may be determined based on the generated first routing call, the generated second routing call and the obtained optimal route 124. Specifically, the linear probability may be determined based on the first factor F1 and the second factor F2 that considers the first set of distances 402 and the second set of distances 404 determined in the first routing call and the second routing call respectively. In an embodiment, the mapping platform 102 may determine the linear probability as multiplication of the F1 and F2. The linear probability may be determined for each of the one or more vehicles.

The linear probability (also represented as Pv) may be represented as:

$$Pv = F 1 \times F 2 \qquad ( 3 )$$

$$i . e . ,$$

$$Pv = [ b / ( a 1 + a 2 ) ] \times [ ( b - a 2 ) / b ] \qquad ( 4 )$$

$$Pv = ( b - a 2 ) / ( a 1 + a 2 ) \qquad ( 5 )$$

As shown in equation 5, the linear probability is determined based on subtraction of the second set of distances 404 from the distance of the optimal route 124 and dividing the subtraction by sum of the first set for distances 402 and the second set of distances 404. The linear probability is determined for each of the one or more vehicles that may have departed from the origin location 120 in the time window of departure of the shipment. A distribution of the linear probability Pv over a geographical region is shown in FIG. 5.

FIG. 5 is a schematic diagram 500 depicting distribution of the linear probability calculated for tracking the shipment, according to one embodiment. In various embodiments, the mapping platform 102 and/or any of the modules 202-210 may perform one or more portions of the operations depicted in the schematic diagram 500 and may be implemented in, for instance, the chip set including the processor and the memory as shown in FIG. 11 and FIG. 12. The schematic diagram 500 may include the origin location 120, the destination location 122 and the optimal route 124. The schematic diagram 500 may further include geographical regions, such as a region 502a, a region 502b, a region 502c, a region 502d, and a region 502e.

The schematic diagram 500 depicts that the linear probability of each vehicle of the one or more vehicles that may be in the same geographical regions may be similar. For example, the first vehicle 118a and the second vehicle 118b may be in the region 502c. In such a case, the linear probability for the first vehicle 118a and the second vehicle 118b may be same or similar. Furthermore, a value of the linear probability for the vehicles that may be in the geographical regions that are near the destination location 122, may be higher. For example, the value of the linear probability may be between zero and one. When the one or more vehicles start from the origin location 120, the value of their respective linear probabilities may be less (e.g., closer to zero). As the one or more vehicles move closer to the destination location 122, the value of their respective linear probabilities may increase. Thus, as the one or more vehicles move across the graphical regions, such as from the region 502e to the region 502d to the region 502e and so forth, the value of their respective linear probabilities may increase and may come closer to one.

Referring again to FIG. 3, at step 316, an exponential probability may be determined. The exponential probability may be determined to calculate the shipment correspondence probability for each of the one or more vehicles. In some embodiments, the mapping platform 102 may be configured to determine the exponential probability associated with each of the one or more vehicles based on a predefined exponential base value, a predefined exponent stretching coefficient and the determined linear probability.

Notably, only one vehicle (such as the shipment vehicle) of the one or more vehicles is actually carrying the shipment, however, each of the remaining vehicles of the one or more vehicles not carrying the shipment may still have contribution distorting the overall shipment correspondence probability for respective vehicle. Therefore, an exponential weight may be considered to magnify effect of the vehicle with highest shipment correspondence probability (such as the shipment vehicle), and to a lesser extent consider the shipment correspondence probability of the remaining vehicles. In order to consider the contribution of each of the one or more vehicles, the mapping platform 102 may determine the exponential probability. The exponential probability (also represented as Pexp) may be determined as follows:

$$P exp = {A}^{( k * Pv )} \qquad ( 6 )$$

where A is the predefined exponential base value and k is the predefined exponent stretching coefficient. In some embodiments, a value of A may be 10. In one or more embodiments, a value of k may be 10. Thus, for each vehicle of the one or more vehicles, the exponential probability may be determined.

In an exemplary scenario, the linear probability for the first vehicle 118a may be 0.56. In such a case, the exponential probability for the first vehicle 118a may be 10^{(10*0.56)}. In another example, the linear probability for the second vehicle 118b may be 0.48. In such a case, the exponential probability for the second vehicle 118b may be 10^{(10*0.48)}. Thus, for each of the one or more vehicles, the exponential probability may be determined.

At step 318, the shipment correspondence probability may be calculated. In some embodiments, the probability calculation module 206 may be configured to calculate the shipment correspondence probability. The shipment correspondence probability may be calculated for each of the one or more vehicles based on divergence of a travelled route (such as a distance of the first set of distances 402) of a respective vehicle of the one or more vehicles from the optimal route 124. In some embodiments, the mapping platform 102 may be configured to calculate the shipment correspondence probability based on the determined linear probability and the exponential probability. The shipment correspondence probability (also represented as Psc) may be calculated as follows:

$$Psc = \frac{{\sum }_{i = 0}^{n} {Pv}_{i} * P {exp}_{i}}{{\sum }_{i = 0}^{n} P {exp}_{i}} \qquad ( 7 )$$

The mapping platform 102 may utilize the equation 7 to calculate the shipment correspondence probability for each of the one or more vehicles. The shipment correspondence probability for a vehicle may be calculated based on the sum of the linear probabilities of each of the one or more vehicles and the exponential probability of the vehicle. For example, a value of the shipment correspondence probability may be in a range of 0 to 1. A higher value of the shipment correspondence probability may indicate a greater likelihood of being the shipment vehicle. For example, the shipment correspondence probability of the first vehicle 118a may be 0.6, and the shipment correspondence probability of the second vehicle 118b may be 0.7. In such a case, the likelihood of the second vehicle 118b being the shipment vehicle may be greater than the first vehicle 118a. The shipment correspondence probability is further described with respect to FIG. 6A and FIG. 6B.

FIG. 6A and FIG. 6B collectively depict schematic diagrams for updating shipment correspondence probability of one or more vehicles based on divergence of a travelled route from an optimal route, according to one embodiment. In various embodiments, the mapping platform 102 and/or any of the modules 202-210 may perform one or more portions of the operations depicted in the schematic diagrams and may be implemented in, for instance, the chip set including the processor and the memory as shown in FIG. 11 and FIG. 12. FIG. 6A depicts a schematic diagram 600A. The schematic diagram 600A may include the origin location 120, the destination location 122 and the optimal route 124. The schematic diagram 600A may further include one or more vehicles, such as the first vehicle 118a, the second vehicle 118b, the third vehicle 118c and the fourth vehicle 118d.

The schematic diagram 600A depicts the current geographical coordinates of the first vehicle 118a, the second vehicle 118b, the third vehicle 118c and the fourth vehicle 118d at a time instant T1. In an exemplary scenario, the first vehicle 118a, the second vehicle 118b, the third vehicle 118c and the fourth vehicle 118d may have departed from the origin destination 120 within the time window of the departure of the shipment. At the time instant T1, the divergence of the travelled route (such as the second distance 402b) of the second vehicle 118b from the optimal route 124 may be least amongst the divergences of the remaining of the one or more vehicles. In such a case, the shipment correspondence probability of the second vehicle 118b may be highest at the time instant T1. For example, the shipment correspondence probability of the second vehicle 118b may be 0.45.

FIG. 6B depicts a schematic diagram 600B. The schematic diagram 600B may include the origin location 120, the destination location 122 and the optimal route 124. The schematic diagram 600B may further include one or more vehicles, such as the first vehicle 118a, the second vehicle 118b, the third vehicle 118c and the fourth vehicle 118d. The schematic diagram 600B depicts the current locations of the first vehicle 118a, the second vehicle 118b, the third vehicle 118c and the fourth vehicle 118d at a time instant T2. At the time instant T2, the divergence of the travelled route (such as the first distance 402a) of the first vehicle 118a from the optimal route 124 may be least amongst the divergences of the remaining of the one or more vehicles. In such a case, the shipment correspondence probability of the first vehicle 118a may be highest at the time instant T2. For example, the shipment correspondence probability of the first vehicle 118a may be 0.93. It may be noted that as the one or more vehicles travel, their shipment correspondence probability may be updated in real time or near real-time based on their respective divergence of the travelled route from the optimal route 124.

Furthermore, in some embodiments, the mapping platform 102 may be configured to determine weighted average of the current geographical coordinates of the shipment vehicle based on the current geographical coordinates and the exponential probability associated with each of the one or more vehicles. For example, till the time the shipment vehicle is not definitely determined, the mapping platform 102 may provide the weighted average of the current geographical coordinates of the shipment vehicle to the shipping provider or the customer.

The current geographical coordinates of the shipment vehicle may include, for example, a current latitude and a current longitude of the shipment vehicle. The weighted average of the current geographical coordinates (represented as Latₐᵥ and Lngₐᵥ) of the shipment vehicle are determined as follows:

$${Lat}_{av} = \frac{{\sum }_{i = 0}^{n} {Lat}_{i} * P {exp}_{i}}{{\sum }_{i = 0}^{n} P {exp}_{i}} \qquad ( 8 )$$

$${Lng}_{av} = \frac{{\sum }_{i = 0}^{n} {Lng}_{i} * P {exp}_{i}}{{\sum }_{i = 0}^{n} P {exp}_{i}} \qquad ( 9 )$$

where Latₐᵥ is the weighted average of the current latitude of the shipment vehicle and Lngₐᵥ is the weighted average of the current longitude of the shipment vehicle.

Referring again to FIG. 3, at step 320, a data structure may be created. In some embodiments, the mapping platform 102 may be configured to create the data structure. The data structure may be kept as records in the shipment tracking database 106. The data structure may be utilized to provide tracking information across several applications and systems as required. Exemplary data structure is shown in FIG. 7.

FIG. 7 is a diagram 700 depicting a data structure 702 that includes information of monitored one or more vehicles for tracking the shipment, according to one embodiment. In various embodiments, the mapping platform 102 and/or any of the modules 202-210 may perform one or more portions of the operations to create the data structure 702 and may be implemented in, for instance, the chip set including the processor and the memory as shown in FIG. 11 and FIG. 12.

Each entry of the data structure 702 may correspond to at least one of the shipment ID of the shipment, the anonymized vehicle ID of the shipment vehicle having the highest value of the shipment correspondence probability, current geographical coordinates of the shipment vehicle having the highest value of the shipment correspondence probability, and a list of the one or more vehicles. For example, an entry 704 may correspond to the shipment ID of the shipment that is being tracked. An entry 706 may correspond to the anonymized vehicle ID of the shipment vehicle. Further, an entry 708 may correspond to the shipment correspondence probability of the shipment vehicle. Furthermore, an entry 710 may correspond to the current geographical coordinates of the shipment vehicle. In an embodiment, the entry 710 may correspond to the weighted average of the current geographical coordinates of the shipment vehicle. Moreover, an entry 712 may correspond to the list of the one or more vehicles being monitored or tracked.

In an example, the entry 706, the entry 708 and the entry 710 may be updated in real-time or near real-time based on update in the shipment correspondence probability for each of the one or more vehicles. For example, till the time instance T1, the shipment correspondence probability of the second vehicle 118b may be highest as explained with FIG. 6A. In such a case, till the time instance T1, the entry 706, the entry 708 and the entry 710 may be associated with the second vehicle 118b. Furthermore, at time instance T2, the shipment correspondence probability of the first vehicle 118a may be highest as explained with FIG. 6B. In such a case, till the time instance T1, the entry 706, the entry 708 and the entry 710 may be associated with the first vehicle 118a.

In some embodiments, the list of the one or more vehicles corresponding to the entry 712 may include at least one of the anonymized vehicle IDs of the one or more vehicles, the calculated shipment correspondence probability for each of the one or more vehicles, and the current geographical coordinates of each of the one or more vehicles. The list of the one or more vehicles may include all vehicles having likelihood of being the shipment vehicle with relevant information required for tracking of the shipment. In an embodiment, at the time of creation of the data structure 702, the shipment correspondence probability for each of the one or more vehicles may set to be 0. The data structure 702 may be created simultaneously with reception of the list of the anonymized vehicle IDs.

In some embodiments, the mapping platform 102 may be configured to periodically update the list of the one or more vehicles in the data structure 702, based on update of at least one of the calculated shipment correspondence probability for each of the one or more vehicles, and the current geographical coordinates of each of the one or more vehicles. For example, the list of the one or more vehicles may be updated based on the periodic retrieval of the anonymized vehicle IDs in the first time period of the time window of departure of the shipment. In such a manner, the list of the one or more vehicles may be updated with all vehicles having likelihood of being the shipment vehicle. The calculated shipment correspondence probability for each of the one or more vehicles may be updated based on the divergence of the travelled route from the optimal route 124. Similarly, as the one or more vehicles travel, the current geographical coordinates may be updated.

Referring again to FIG. 3, at step 322, the shipment vehicle may be determined. In some embodiments, the mapping platform 102 may be configured to determine the shipment vehicle of the one or more vehicles based on the calculated shipment correspondence probability. In an embodiment, the shipment vehicle determination module 208 may be configured to determine the shipment vehicle. The shipment vehicle may be the vehicle actually carrying the shipment. For example, the vehicle of the one or more vehicles having the highest shipment correspondence probability may be considered as the shipment vehicle.

In some embodiments, the mapping platform 102 may be configured to update the calculated shipment correspondence probability for each of the one or more vehicles based on the divergence of the travelled route of the respective vehicle from the optimal route 124, until the calculated shipment correspondence probability of the shipment vehicle is more than or equal to a threshold. In an example, the threshold may be 0.8. In such a case, once the shipment correspondence probability for any of the one or more vehicles may be determined to be more than or equal to the threshold, the mapping platform 102 may determine that vehicle as the definite shipment vehicle. The mapping platform 102 may then stop the calculation of the shipment correspondence probability for the one or more vehicles and update the shipment correspondence probability of the shipment vehicle as 1. For example, once the shipment correspondence probability of the first vehicle 118a may be calculated as 0.93, the mapping platform 102 may determine the first vehicle 118a as the shipment vehicle.

In some embodiments, the tracking operation of the shipment may be stopped by the mapping platform 102 based on the determination that the weighted average of the current geographical coordinates of the shipment vehicle is within a predefined vicinity of the destination location 122. For example, a range of the predefined vicinity may be a few meters from the destination location 122. In an example, when the shipment vehicle is within a 100 meters from the destination location 122, the tracking operation of the shipment may be stopped and may be considered as complete. In one or more embodiments, the vehicle ID, such as the license number of the shipment vehicle may be confirmed or verified by the shipment vehicle actually carrying the shipment. In such a case, the tracking of only the shipment vehicle that is verified may be performed.

At step 324, a notification may be provided. The mapping platform 102 may be configured to provide the notification corresponding to the tracking information associated with the shipment vehicle, via the tracking application. In an embodiment, the notification providing module 210 may be configured to provide the notification. In some embodiments, the tracking information may include at least the weighted average of the current geographical coordinates of the shipment vehicle and an estimated time of arrival of the shipment vehicle at the destination location. For example, the weighted average of the current geographical coordinates of the shipment vehicle may be determined as explained with equations 8 and 9. The tracking information may be provided to the shipping provider or the customer as the notification.

In some embodiments, the mapping platform 102 may be configured to provide the notification corresponding to the tracking information associated with the shipment vehicle via the tracking application, based on a determination that the calculated shipment correspondence probability for the shipment vehicle has a highest value amongst the calculated shipment correspondence probability for each of the one or more vehicles. For example, as shown in FIG. 6A, till the time instant T1, the shipment correspondence probability of the second vehicle 118b may be highest amongst the calculated shipment correspondence probability for each of the one or more vehicles. In such a case, the mapping platform 102 may provide the notification corresponding to the tracking information of the second vehicle 118b via the tracking application 110 till the time instant T1.

In some embodiments, the mapping platform 102 may be configured to provide the notification corresponding to the tracking information associated with the shipment vehicle via the tracking application, based on a determination that the calculated shipment correspondence probability for the shipment vehicle is more than or equal to the threshold. For example, as shown in FIG. 6B, at the time instant T2, the shipment correspondence probability (e.g., 0.93) of the first vehicle 118a may be highest, and may be more than the threshold (e.g., 0.8). In such a case, the mapping platform 102 may provide the notification corresponding to the tracking information of the first vehicle 118a via the tracking application 110 at the time instant T2.

For example, the notification may be handled by other systems that may render the shipment vehicle location on a map, or may trigger some actions, such as communication of the notification with the components of the system 100 via an application programming interface (API), making the shipment vehicle location information available for shipment logging, storage on databases, initiating workflow actions, and the like. In an embodiment, the notification may be provided as rendered information on the user interface 108a as shown in FIG. 8.

FIG. 8 is a diagram 800 depicting the user interface 108a with rendered shipment information and tracking information, according to one embodiment. In various embodiments, the mapping platform 102 and/or any of the modules 202-210 may perform one or more portions of the operations to provide the notification and may be implemented in, for instance, the chip set including the processor and the memory as shown in FIG. 11 and FIG. 12.

The diagram 800 depicts the user interface 108a. The user interface 108a shows the rendered tracking information and the shipment information. In some embodiments, the mapping platform 102 may be configured to update shipment information of the shipment with the tracking information associated with the shipment vehicle. The mapping platform 102 may further provide the notification corresponding to the shipment information along with the tracking information via the tracking application.

For example, the tracking information rendered on the user interface 108a may be accessed by the shipping provider or the customer by using a user interface icon 802. The mapping platform 102 may be configured to provide the weighted average of the geographical coordinates of the shipment vehicle and the associated shipment correspondence probability once the user, such as the shipping provider or the customer may click on the user interface icon 802. Once the shipment correspondence probability is more than the threshold, the shipment correspondence probability may be updated as 1. In some cases, by clicking the user interface icon 802, the real-time or near real-time geographical coordinates of the shipment vehicle may be displayed on a map. Along with the tracking information, the shipment information such as the shipment ID, a current status of the shipment, a next destination of the shipment and the estimated date and time of arrival of the shipment may be rendered on the user interface 108a. Some embodiments may also render the coordinates on a map, resolve the coordinates as an address on the road network, or the like.

Referring again to FIG. 3, at step 326, the shipment tracking database 106 may be updated. In some embodiments, the mapping platform 102 may be configured to update the shipment tracking database 106 with the shipment information of the shipment and the tracking information of the shipment vehicle. For example, the updated shipment information may include the anonymized vehicle ID of the shipment vehicle and the estimated time of arrival of the shipment. Thus, for each shipment, the shipment information may be updated with the tracking information of the shipment vehicle that is carrying the vehicle.

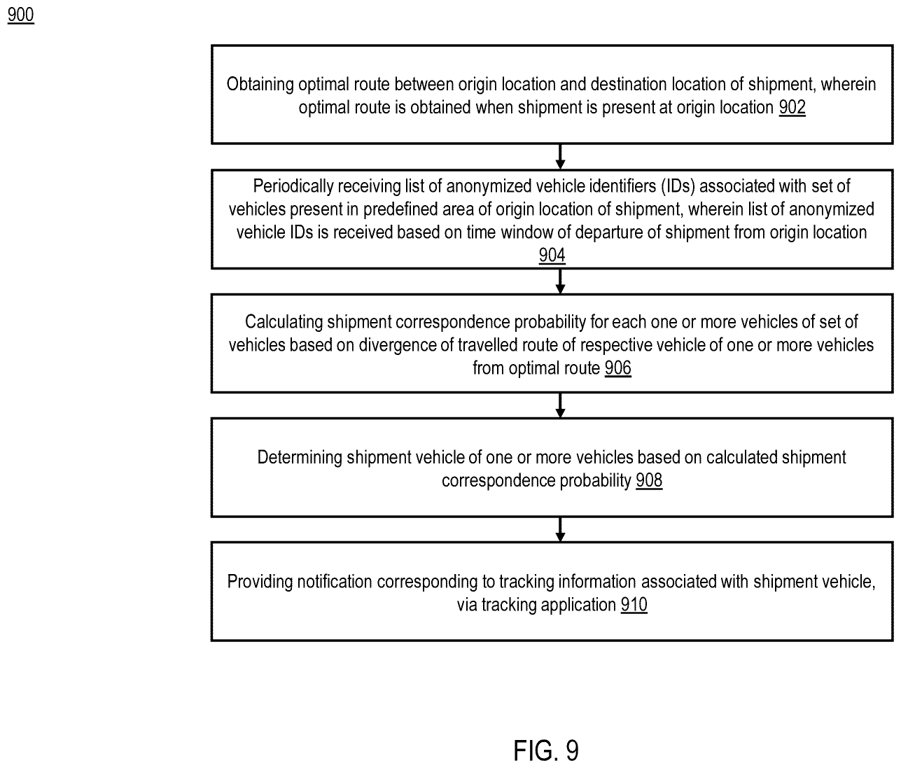

FIG. 9 is a flowchart of a method 900 for tracking the shipment, according to one embodiment. In various embodiments, the mapping platform 102 and/or any of the modules 202-210 may perform one or more portions of the method 900 and may be implemented in, for instance, the chip set including the processor and the memory as shown in FIG. 11 and FIG. 12. As such, the mapping platform 102 and/or any of the modules 202-210 may provide means for accomplishing various parts of the method 900, as well as means for accomplishing embodiments of other processes described herein in conjunction with other components of the system 100. Although the method 900 is illustrated and described as a sequence of steps, it is contemplated that various embodiments of the method 900 may be performed in any order or combination and need not include all of the illustrated steps.

At step 902, the optimal route 124 may be obtained. The mapping platform 102 may be configured to obtain the optimal route 124 between the origin location 120 and the destination location 122 of the shipment. Once the shipment ID is received and the shipment information is extracted, the mapping platform 102 may obtain the optimal route 124. The optimal route 124 may be for example, a preferred route or a shortest route between the origin location 120 and the destination location 122. The optimal route 124 may be determined based on several factors, such as a time of a day, traffic conditions, construction works between the origin location 120 and the destination location 122, and the like. Details of obtaining the optimal route 124 are further provided, for example, at step 306 in FIG. 3.

At step 904, the list of anonymized vehicle IDs may be received. The mapping platform 102 may be configured to periodically receive the list of anonymized vehicle IDs associated with the set of vehicles 118 present in the predefined area 120a of the origin location 120. Each of the anonymized vehicle ID may be for example, a unique string of alphanumeric characters assigned to a vehicle of the set of vehicles 118. Details of reception of the list of anonymized vehicle IDs are further provided, for example, at step 308 in FIG. 3.

At step 906, the shipment correspondence probability may be calculated. The shipment correspondence probability may be calculated for each of the one or more vehicles based on divergence of a travelled route (such as a distance of the first set of distances 402) of a respective vehicle of the one or more vehicles from the optimal route 124. In some embodiments, the mapping platform 102 may be configured to calculate the shipment correspondence probability based on the determined linear probability and the exponential probability. Details of calculation of the shipment correspondence probability are further provided, for example, at step 318 in FIG. 3.

At step 908, the shipment vehicle may be determined. In some embodiments, the mapping platform 102 may be configured to determine the shipment vehicle of the one or more vehicles based on the calculated shipment correspondence probability. The shipment vehicle may be the vehicle actually carrying the shipment. For example, the vehicle of the one or more vehicles having the highest shipment correspondence probability may be considered as the shipment vehicle. Details of determining the shipment vehicle are further provided, for example, at step 322 in FIG. 3.

At step 910, the notification may be provided. The mapping platform 102 may be configured to provide the notification corresponding to the tracking information associated with the shipment vehicle, via the tracking application. In some embodiments, the tracking information may include at least the weighted average of the current geographical coordinates of the shipment vehicle and an estimated time of arrival of the shipment vehicle at the destination location. Details of providing the notification are further provided, for example, at step 324 in FIG. 3.

Returning to FIG. 1, as shown, the system 100 includes the mapping platform 102 for tracking the shipment. In one embodiment, the mapping platform 102 has connectivity over the communication network 126 to the services platform 112 that provides the one or more services, such as the service 112a and the service 112n that can use the vehicle data, such as the geographical coordinates of the vehicles for downstream functions. By way of example, the service 112a and the service 112n may be third party services and include but is not limited to the telematics services, mapping services, navigation services, travel planning services, notification services, social networking services, content (e.g., audio, video, images, etc.) provisioning services, application services, storage services, contextual information determination services, location-based services, information-based services (e.g., weather, news, etc.), etc. For example, the service 112a may be associated with the telematics platform and may include the anonymized vehicle IDs database 14. In one embodiment, the service 112a and the service 112n provide the vehicle information, such as the anonymized vehicles IDs and the geographical coordinates of the vehicles to the mapping platform 102. The service 112a and the service 112n may also utilize data from the mapping platform 102 (e.g., the shipment information stored in the shipment tracking database 106 and the optimal route information stored in the geographic database 104, etc.) to provide services such as navigation, mapping, other location-based services, etc. to the UE 108, the applications, such as the tracking application 110, and/or other client devices.

In one embodiment, the mapping platform 102 may be a platform with multiple interconnected components. The mapping platform 102 may include multiple servers, intelligent networking devices, computing devices, components, and corresponding software for computation of the shipment correspondence probability according to the various embodiments described herein. In addition, it is noted that the mapping platform 102 may be a separate entity of the system 100, a part of the service 112a and the service 112n, a part of the services platform 112, or included within components of the UE 108. The mapping platform 102 may be associated with the shipment tracking database 106 that may be configured to store the shipment IDs of the shipments, their shipment and the tracking information.

In one embodiment, the content providers 116 may provide content or data (e.g., probe data of the one or more vehicles, related geographic data, etc.) to the geographic database 104, the mapping platform 102, the services platform 112, the service 112a and the service 112n, the UE 108, and/or the tracking application 110 executing on the UE 108. The content provided may be any type of content, such as the sensor data, imagery, probe data, machine learning models, permutations matrices, map embeddings, map content, textual content, video content, image content, etc. associated with the optimal route 124 and the one or more vehicles. In one embodiment, the content providers 116 may provide content that may aid in tracking the shipment according to the various embodiments described herein. In one embodiment, the content providers 116 may also store content associated with the geographic database 104, the mapping platform 102, the services platform 112, the service 112a and the service 112n, and/or any other component of the system 100. In another embodiment, the content providers 116 may manage access to a central repository of data, and offer a consistent, standard interface to data, such as a repository of the geographic database 104.

In one embodiment, the UE 108 may execute software applications, such as the tracking application 110 to use the tracking information, the shipment information or other data derived therefrom according to the embodiments described herein. By way of example, the tracking application 110 may also be any type of application that is executable on the UE 108, such as autonomous driving applications, routing applications, mapping applications, location-based service applications, navigation applications, device control applications, content provisioning services, camera/imaging application, media player applications, social networking applications, calendar applications, and the like. In one embodiment, the tracking application 110 may function as a client for the mapping platform 102 and perform one or more functions associated with tracking of the shipment alone or in combination with the mapping platform 102.

By way of example, the UE 108 are or can include any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 108 can support any type of interface to the user (such as “wearable” circuitry, etc.). In one embodiment, the UE 108 may be associated with or be a component of a vehicle or any other device. The UE 108 may be configured to display the user interface 108a to provide the tracking information to the users.

In one embodiment, the UE 108 is configured with various sensors for generating or collecting the related geographic data, etc. By way of example, the sensors may include a global positioning sensor for gathering location data (e.g., GPS, GALILEO, BEIDOU, GLONASS), IMUs, a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data (e.g., the camera sensors may automatically capture road sign information, images of road obstructions, etc. for analysis), an audio recorder for gathering audio data, velocity sensors mounted on steering wheels of the vehicles, switch sensors for determining whether one or more vehicle switches are engaged, and the like.

Other examples of sensors of the UE 108 may include light sensors, orientation sensors augmented with height sensors and acceleration sensor, tilt sensors to detect the degree of incline or decline (e.g., slope) along a path of travel, moisture sensors, pressure sensors, etc. In a further example embodiment, sensors about the perimeter of the UE 108 may detect the relative distance of the device or vehicle from a lane or roadway, the presence of other vehicles, pedestrians, traffic lights, potholes and any other objects, or a combination thereof. In one scenario, the sensors may detect weather data, traffic information, or a combination thereof. In one embodiment, the UE 108 may include GPS or other satellite-based receivers to obtain geographic coordinates from positioning satellites for determining current location and time. Further, the location can be determined by visual odometry, triangulation systems such as A-GPS, Cell of Origin, or other location extrapolation technologies.

In one embodiment, the communication network 126 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, 5G New Radio networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the mapping platform 102, the services platform 112, the service 112a and the service 112n, the UE 108, and/or the content providers 116 communicate with each other and other components of the system 100 using well known, new or still developing protocols. In this context, a protocol includes a set of rules defining how the network nodes within the communication network 126 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a datalink (layer 2) header, an internetwork (layer 3) header and a transport (layer 4) header, and various application (layer 5, layer 6 and layer 7) headers as defined by the OSI Reference Model.

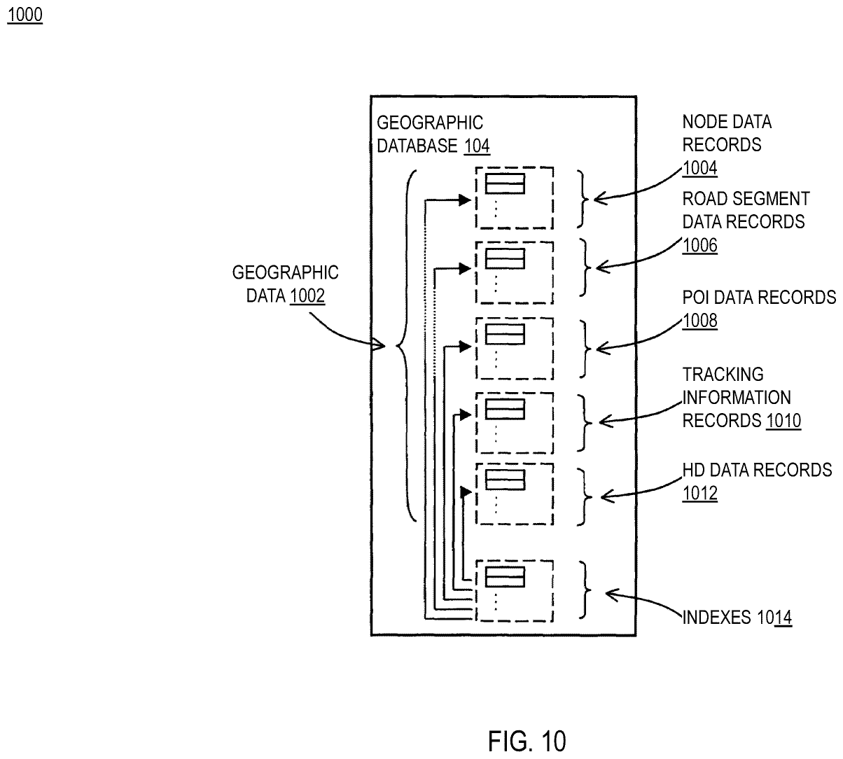

FIG. 10 is a diagram of the geographic database 104, according to one embodiment. In one embodiment, the geographic database 104 includes geographic data 1002 used for (or configured to be compiled to be used for) mapping and/or navigation-related services, such as for providing map embedding analytics according to the embodiments described herein. For example, the map data records stored herein can be used to determine the semantic relationships among the map features, attributes, categories, etc. represented in the geographic data 1002. In one embodiment, the geographic database 104 includes high definition (HD) mapping data that provide centimeter-level or better accuracy of map features. For example, the geographic database 104 can be based on Light Detection and Ranging (LiDAR) or equivalent technology to collect billions of 3D points and model road surfaces and other map features down to the number lanes and their widths. In one embodiment, the HD mapping data (e.g., HD data records 1012) and/or other mapping data of the geographic database 104 capture and store details such as but not limited to road attributes and/or other features related to generating speed profile data. These details include but are not limited to road width, number of lanes, turn maneuver representations/guides, traffic lights, light timing/stats information, slope and curvature of the road, lane markings, roadside objects such as signposts, including what the signage denotes. By way of example, the HD mapping data enable highly automated vehicles to precisely localize themselves on the road.

In one embodiment, geographic features (e.g., two-dimensional, or three-dimensional features) are represented using polylines and/or polygons (e.g., two-dimensional features) or polygon extrusions (e.g., three-dimensional features). In one embodiment, these polylines/polygons can also represent ground truth or reference features or objects (e.g., signs, road markings, lane lines, landmarks, etc.) used for visual odometry. For example, the polylines or polygons can correspond to the boundaries or edges of the respective geographic features. In the case of a building, a two-dimensional polygon can be used to represent a footprint of the building, and a three-dimensional polygon extrusion can be used to represent the three-dimensional surfaces of the building. Accordingly, the terms polygons and polygon extrusions as used herein can be used interchangeably.

In one embodiment, the following terminology applies to the representation of geographic features in the geographic database 104.

“Node”—A point that terminates a link.

“Line segment”—A straight line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 104 follows certain conventions. For example, links do not cross themselves and do not cross each other except at a node. Also, there are no duplicated shape points, nodes, or links. Two links that connect each other have a common node. In the geographic database 104, overlapping geographic features are represented by overlapping polygons. When polygons overlap, the boundary of one polygon crosses the boundary of the other polygon. In the geographic database 104, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 104 includes node data records 1004, road segment or link data records 1006, POI data records 1008, tracking information records 710, HD mapping data records 1012, and indexes 1014, for example. More, fewer, or different data records can be provided. In some embodiments, the tracking information records 1010 may be stored in the shipment tracking database 106. In one embodiment, additional data records (not shown) can include cartographic (“carto”) data records, routing data, and maneuver data. In one embodiment, the indexes 1014 may improve the speed of data retrieval operations in the geographic database 104. In one embodiment, the indexes 1014 may be used to quickly locate data without having to search every row in the geographic database 104 every time it is accessed. For example, in one embodiment, the indexes 1014 can be a spatial index of the polygon points associated with stored feature polygons. In one or more embodiments, data of a data record may be attributes of another data record.

In exemplary embodiments, the road segment data records 1006 are links or segments representing roads, streets, paths, or bicycle lanes, as can be used in the calculated route or recorded route information for determination of speed profile data. The node data records 1004 are end points (for example, representing intersections or an end of a road) corresponding to the respective links or segments of the road segment data records 1006. The road segment data records 1006 and the node data records 1004 represent a road network, such as used by vehicles, cars, and/or other entities. Alternatively, the geographic database 104 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 104 can include data about the POIs and their respective locations in the POI data records 1008. The geographic database 104 can also include data about road attributes (e.g., traffic lights, stop signs, yield signs, roundabouts, lane count, road width, lane width, etc.), places, such as cities, towns, or other communities, and other geographic features, such as bodies of water, mountain ranges, etc. Such place or map feature data can be part of the POI data records 708 or can be associated with POIs or POI data records 1008 (such as a data point used for displaying or representing a position of a city).

In one embodiment, the geographic database 104 can also include the tracking information records 1010 for storing the tracking information, shipment information, trained machine learning models, and/or any other related data that is used or generated according to the embodiments described herein. By way of example, the tracking information records 1010 can be associated with one or more of the node records 1004, the road segment records 1006, and/or the POI data records 1008 to associate the speed profile data records with specific places, POIs, geographic areas, and/or other map features. In this way, the linearized data records can also be associated with the characteristics or metadata of the corresponding records 1004, 1006, and/or 1008.

In one embodiment, as discussed above, the HD mapping data records 1012 model road surfaces and other map features to centimeter-level or better accuracy. The HD mapping data records 1012 also include ground truth object models that provide the precise object geometry with polylines or polygonal boundaries, as well as rich attributes of the models. These rich attributes include, but are not limited to, object type, object location, lane traversal information, lane types, lane marking types, lane level speed limit information, and/or the like. In one embodiment, the HD mapping data records 1012 are divided into spatial partitions of varying sizes to provide HD mapping data to end user devices with near real-time speed without overloading the available resources of the devices (e.g., computational, memory, bandwidth, etc. resources).

In one embodiment, the HD mapping data records 1012 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the HD mapping data records 1012.

In one embodiment, the HD mapping data records 1012 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time data (e.g., including probe trajectories) also at centimeter-level accuracy. Other sensor data can include vehicle telemetry or operational data such as windshield wiper activation state, braking state, steering angle, accelerator position, and/or the like.

In one embodiment, the geographic database 104 can be maintained by the content provider 116 in association with the mapping platform 102 (e.g., a map developer or service provider). The map developer can collect geographic data to generate and enhance the geographic database 104. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database 104 can be a master geographic database stored in a format that facilitates updating, maintenance, and development. For example, the master geographic database or data in the master geographic database can be in an Oracle spatial format or other format (e.g., capable of accommodating multiple/different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF)) to organize and/or configure the data for performing navigation-related functions and/or services, such as route calculation, route guidance, map display, speed calculation, distance and travel time functions, and other functions, by a navigation device, such as by vehicle and/or the UE 108. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for tracking of the shipment may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 11 is a diagram of hardware that can be used to implement an embodiment. Computer system 1100 is programmed (e.g., via computer program code or instructions) for tracking of the shipment as described herein and includes a communication mechanism such as a bus 1110 for passing information between other internal and external components of the computer system 1100. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

The bus 1110 includes one or more parallel conductors of information so that information is transferred quickly among devices coupled to the bus 1110. One or more processors 1102 for processing information are coupled with the bus 1110.

A processor 1102 performs a set of operations on information as specified by computer program code related to tracking of the shipment. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1110 and placing information on the bus 1110. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1102, such as a sequence of operation codes, constitute processor instructions, also called computer system instructions or, simply, computer instructions. Processors may be implemented as mechanical, electrical, magnetic, optical, chemical or quantum components, among others, alone or in combination.

The computer system 1100 also includes a memory 1104 coupled to bus 1110. The memory 1104, such as a random access memory (RAM) or other dynamic storage device, stores information including processor instructions for tracking of the shipment. Dynamic memory allows information stored therein to be changed by the computer system 1100. RAM allows a unit of information stored at a location called a memory address to be stored and retrieved independently of information at neighboring addresses. The memory 1104 is also used by the processor 1102 to store temporary values during execution of processor instructions. The computer system 1100 also includes a read only memory (ROM) 1106 or other static storage device coupled to the bus 1110 for storing static information, including instructions, which is not changed by the computer system 1100. Some memory is composed of volatile storage that loses the information stored thereon when power is lost. Also coupled to the bus 1110 is a non-volatile (persistent) storage device 1108, such as a magnetic disk, optical disk, or flash card, for storing information, including instructions, which persists even when the computer system 1100 is turned off or otherwise loses power.

Information, including instructions for tracking of the shipment, is provided to the bus 1110 for use by the processor from an external input device 1112, such as a keyboard containing alphanumeric keys operated by a human user, or a sensor. A sensor detects conditions in its vicinity and transforms those detections into physical expression compatible with the measurable phenomenon used to represent information in computer system 1100. Other external devices coupled to bus 1110, used primarily for interacting with humans, include a display device 1114, such as a cathode ray tube (CRT) or a liquid crystal display (LCD), or plasma screen or printer for presenting text or images, and a pointing device 1116, such as a mouse or a trackball or cursor direction keys, or motion sensor, for controlling a position of a small cursor image presented on the display 1114 and issuing commands associated with graphical elements presented on the display 1114. In some embodiments, for example, in embodiments in which the computer system 1100 performs all functions automatically without human input, one or more of external input device 1112, display device 1114 and pointing device 1116 is omitted.

In the illustrated embodiment, special purpose hardware, such as an application specific integrated circuit (ASIC) 1118, is coupled to the bus 1110. The special purpose hardware is configured to perform operations not performed by processor 1102 quickly enough for special purposes. Examples of application specific ICs include graphics accelerator cards for generating images for display 1114, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

The computer system 1100 also includes one or more instances of a communications interface 1120 coupled to bus 1110. The communication interface 1120 provides a one-way or two-way communication coupling to a variety of external devices that operate with their own processors, such as printers, scanners, and external disks. In general, the coupling is with a network link 1122 that is connected to a local network 1124 to which a variety of external devices with their own processors are connected. For example, the communication interface 1120 may be a parallel port or a serial port or a universal serial bus (USB) port on a personal computer. In some embodiments, communications interface 1120 is an integrated services digital network (ISDN) card or a digital subscriber line (DSL) card or a telephone modem that provides an information communication connection to a corresponding type of telephone line. In some embodiments, the communication interface 1120 is a cable modem that converts signals on the bus 1110 into signals for a communication connection over a coaxial cable or into optical signals for a communication connection over a fiber optic cable. As another example, communications interface 1120 may be a local area network (LAN) card to provide a data communication connection to a compatible LAN, such as Ethernet. Wireless links may also be implemented. For wireless links, the communications interface 1120 sends or receives or both sends and receives electrical, acoustic, or electromagnetic signals, including infrared and optical signals, which carry information streams, such as digital data. For example, in wireless handheld devices, such as mobile telephones like cell phones, the communications interface 1120 includes a radio band electromagnetic transmitter and receiver called a radio transceiver. In certain embodiments, the communications interface 1120 enables connection to the communication network 126 for tracking of the shipment.

The term computer-readable medium is used herein to refer to any medium that participates in providing information to processor 1102, including instructions for execution. Such a medium may take many forms, including, but not limited to, non-volatile media, volatile media, and transmission media. Non-volatile media include, for example, optical or magnetic disks, such as storage device 1108. Volatile media include, for example, dynamic memory 1104. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 1122 typically provides information communication using transmission media through one or more networks to other devices that use or process the information. For example, the network link 1122 may provide a connection through local network 1124 to a host computer 1126 or to equipment 1128 operated by an Internet Service Provider (ISP). ISP equipment 1128 in turn provides data communication services through the public, world-wide packet-switching communication network of networks now commonly referred to as the Internet 1130.

A computer called a server host 1132 connected to the Internet hosts a process that provides a service in response to information received over the Internet. For example, server host 1132 hosts a process that provides information representing video data for presentation at display 1114. It is contemplated that the components of system can be deployed in various configurations within other computer systems, e.g., host 1126 and server 1132.

FIG. 12 is a diagram of a chip set 1200 that can be used to implement an embodiment. The chip set 1200 is programmed to track the shipment as described herein and includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1200 includes a communication mechanism such as a bus 1202 for passing information among the components of the chip set 1200. A processor 1204 has connectivity to the bus 1202 to execute instructions and process information stored in, for example, a memory 1206. The processor 1204 may include one or more processing cores with each core configured to perform independently. A multi-core processor enables multiprocessing within a single physical package. Examples of a multi-core processor include two, four, eight, or greater numbers of processing cores. Alternatively, or in addition, the processor 1204 may include one or more microprocessors configured in tandem via the bus 1202 to enable independent execution of instructions, pipelining, and multithreading. The processor 1204 may also be accompanied with one or more specialized components to perform certain processing functions and tasks such as one or more digital signal processors (DSP) 1208, or one or more application-specific integrated circuits (ASIC) 1210. A DSP 1208 typically is configured to process real-world signals (e.g., sound) in real time independently of the processor 1204. Similarly, an ASIC 1210 can be configured to perform specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1204 and accompanying components have connectivity to the memory 1206 via the bus 1202. The memory 1206 includes both dynamic memory (e.g., RAM, magnetic disk, writable optical disk, etc.) and static memory (e.g., ROM, CD-ROM, etc.) for storing executable instructions that when executed perform the inventive steps described herein to track of the shipment. The memory 1206 also stores the data associated with or generated by the execution of the inventive steps.

FIG. 13 is a diagram of a mobile terminal 1302 (e.g., handset, vehicle, or part thereof) that can be used to implement an embodiment. Generally, a radio receiver is often defined in terms of front-end and back-end characteristics. The front-end of the receiver encompasses all of the Radio Frequency (RF) circuitry whereas the back end encompasses all of the base-band processing circuitry. Pertinent internal components of the telephone include a Main Control Unit (MCU) 1304, a Digital Signal Processor (DSP) 1306, and a receiver/transmitter unit including a microphone gain control unit and a speaker gain control unit. A main display unit 1308 provides a display to the user in support of various applications and mobile station functions that offer automatic contact matching. An audio function circuitry 1310 includes a microphone 1312 and microphone amplifier that amplifies the speech signal output from the microphone 1312. The amplified speech signal output from the microphone 1312 is fed to a coder/decoder (CODEC) 1314.

A radio section 1330 amplifies power and converts frequency in order to communicate with a base station, which is included in a mobile communication system, via antenna 1352. The power amplifier (PA) 1340 and the transmitter/modulation circuitry are operationally responsive to the MCU 1004, with an output from the PA 1340 coupled to the duplexer 1342 or circulator or antenna switch, as known in the art. The PA 1340 also couples to a battery interface and power control unit 1354.

In use, a user of mobile station 1302 speaks into the microphone 1312 and his or her voice along with any detected background noise is converted into an analog voltage. The analog voltage is then converted into a digital signal through the Analog to Digital Converter (ADC) 1316. The control unit 1304 routes the digital signal into the DSP 1306 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, 5G New Radio networks, code division multiple access (CDMA), wireless fidelity (Wi-Fi), satellite, and the like.

The encoded signals are then routed to an equalizer 1328 for compensation of any frequency-dependent impairments that occur during transmission though the air such as phase and amplitude distortion. After equalizing the bit stream, the modulator 1336 combines the signal with an RF signal generated in the RF interface 1334. The modulator 1336 generates a sine wave by way of frequency or phase modulation. In order to prepare the signal for transmission, an up-converter 1338 combines the sine wave output from the modulator 1336 with another sine wave generated by a synthesizer 1348 to achieve the desired frequency of transmission. The signal is then sent through a PA 1340 to increase the signal to an appropriate power level. In practical systems, the PA 1340 acts as a variable gain amplifier whose gain is controlled by the DSP 1306 from information received from a network base station. The signal is then filtered within the duplexer 1342 and optionally sent to an antenna coupler 1350 to match impedances to provide maximum power transfer. Finally, the signal is transmitted via antenna 1352 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1302 are received via antenna 1352 and immediately amplified by a low noise amplifier (LNA) 1344. A down-converter 1346 lowers the carrier frequency while the demodulator 1332 strips away the RF leaving only a digital bit stream. The signal then goes through the equalizer 1328 and is processed by the DSP 1306. A Digital to Analog Converter (DAC) 1318 converts the signal and the resulting output is transmitted to the user through the speaker 1320, all under control of a Main Control Unit (MCU) 1304—which can be implemented as a Central Processing Unit (CPU) (not shown).

The MCU 1304 receives various signals including input signals from the keyboard 1324. The keyboard 1324 and/or the MCU 1304 in combination with other user input components (e.g., the microphone 1312) comprise a user interface circuitry for managing user input. The MCU 1304 runs a user interface software to facilitate user control of at least some functions of the mobile station 1302 for tracking of the shipment. The MCU 1304 also delivers a display command and a switch command to the display 1308 and to the speech output switch controller, respectively. Further, the MCU 1304 exchanges information with the DSP 1306 and can access an optionally incorporated SIM card 1326 and a memory 1322. In addition, the MCU 1304 executes various control functions required of the station. The DSP 1306 may, depending upon the implementation, perform any of a variety of conventional digital processing functions on the voice signals. Additionally, DSP 1306 determines the background noise level of the local environment from the signals detected by microphone 1312 and sets the gain of microphone 1312 to a level selected to compensate for the natural tendency of the user of the mobile station 1302.

The CODEC 1314 includes the ADC 1316 and DAC 1318. The memory 1322 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1322 may be, but not limited to, a single memory, CD, DVD, ROM, RAM, EEPROM, optical storage, or any other non-volatile or non-transitory storage medium capable of storing digital data.

An optionally incorporated SIM card 1326 carries, for instance, important information, such as the cellular phone number, the carrier supplying service, subscription details, and security information. The SIM card 1326 serves primarily to identify the mobile station 1302 on a radio network. The card 1326 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A system for tracking a shipment, the system comprising:
at least one processor; and
at least one memory including computer program code for one or more programs,
the at least one memory and the computer program code configured to, with the at least one processor, cause the system to perform at least the following:
obtain an optimal route between an origin location and a destination location of the shipment, wherein the optimal route is obtained when the shipment is present at the origin location;
periodically receive a list of anonymized vehicle identifiers (IDs) associated with a set of vehicles present in a predefined area of the origin location of the shipment, wherein the list of the anonymized vehicle IDs is received based on a time window of departure of the shipment from the origin location;
calculate a shipment correspondence probability for each one or more vehicles of the set of vehicles based on divergence of a travelled route of a respective vehicle of the one or more vehicles from the optimal route;
determine a shipment vehicle of the one or more vehicles based on the calculated shipment correspondence probability; and
provide a notification corresponding to tracking information associated with the shipment vehicle, via a tracking application.

2. The system of claim 1, wherein the system is further caused to:
receive a shipment identifier (ID) of the shipment;
extract shipment information linked with the received shipment ID, wherein the shipment information comprises at least one of: the origin location, the destination location, and the time window of departure of the shipment from the origin location; and
periodically receive the list of anonymized vehicle IDs from a telematics platform, based on the extracted shipment information, wherein the list of anonymized vehicle IDs is received periodically for a first time period associated with the time window of departure of the shipment.

3. The system of claim 2, wherein the system is further caused to:
initiate tracking of the one or more vehicles based on periodic reception of current geographical coordinates of the one or more vehicles from the telematics platform; and
determine the divergence of the travelled route of the respective vehicle of the one or more vehicles based on the initiated tracking.

4. The system of claim 1, wherein the system is further caused to update the calculated shipment correspondence probability for each of the one or more vehicles based on the divergence of the travelled route of the respective vehicle from the optimal route, until the calculated shipment correspondence probability of the shipment vehicle is more than or equal to a threshold.

5. The system of claim 1, wherein the system is further caused to:
update shipment information of the shipment with the tracking information associated with the shipment vehicle; and
provide the notification corresponding to the shipment information along with the tracking information via the tracking application.

6. The system of claim 1, wherein the tracking information comprises at least a weighted average of current geographical coordinates of the shipment vehicle and an estimated time of arrival of the shipment vehicle at the destination location.

7. The system of claim 6, wherein, to calculate the shipment correspondence probability for each of the one or more vehicles, the system is further caused to:
generate a first routing call to determine a first set of distances, wherein a distance of the first set of distances is determined between the origin location of the shipment and the current geographical coordinates of a respective vehicle of the one or more vehicles; and
generate a second routing call to determine a second set of distances, wherein a distance of the second set of distances is determined between the current geographical coordinates of each of the respective vehicle and the destination location of the shipment.

8. The system of claim 7, wherein, to calculate the shipment correspondence probability for each of the one or more vehicles, the system is further caused to determine a linear probability associated with each of the one or more vehicles based on the generated first routing call, the generated second routing call and the obtained optimal route.

9. The system of claim 8, wherein, to calculate the shipment correspondence probability for each of the one or more vehicles, the system is further caused to determine an exponential probability associated with each of the one or more vehicles based on a predefined exponential base value, a predefined exponent stretching coefficient and the linear probability.

10. The system of claim 9, wherein the system is further caused to determine the weighted average of the current geographical coordinates of the shipment vehicle based on the current geographical coordinates and the exponential probability associated with each of the one or more vehicles.

11. The system of claim 1, wherein the system is caused to provide the notification corresponding to the tracking information associated with the shipment vehicle via the tracking application, based on a determination that the calculated shipment correspondence probability for the shipment vehicle is more than or equal to a threshold.

12. The system of claim 1, wherein the system is further caused to provide the notification corresponding to the tracking information associated with the shipment vehicle via the tracking application, based on a determination that the calculated shipment correspondence probability for the shipment vehicle has a highest value amongst the calculated shipment correspondence probability for each of the one or more vehicles.

13. The system of claim 12, wherein the system is further caused to create a data structure associated with the shipment, and
wherein each entry of the data structure corresponds to at least one of: a shipment identifier (ID) of the shipment, an anonymized vehicle ID of the shipment vehicle having the highest value of the shipment correspondence probability, current geographical coordinates of the shipment vehicle having the highest value of the shipment correspondence probability, and a list of the one or more vehicles.

14. The system of claim 13, wherein the list of the one or more vehicles comprises at least one of: the anonymized vehicle IDs of the one or more vehicles, the calculated shipment correspondence probability for each of the one or more vehicles, and the current geographical coordinates of each of the one or more vehicles.

15. The system of claim 13, wherein the system is further caused to periodically update the list of the one or more vehicles in the data structure, based on update of at least one of: the calculated shipment correspondence probability for each of the one or more vehicles, and the current geographical coordinates of each of the one or more vehicles.

16. A method for tracking a shipment, comprising:
obtaining an optimal route between an origin location and a destination location of the shipment, wherein the optimal route is obtained when the shipment is present at the origin location;
periodically receiving a list of anonymized vehicle identifiers (IDs) associated with a set of vehicles present in a predefined area of the origin location of the shipment, wherein the list of the anonymized vehicle IDs is received based on a time window of departure of the shipment from the origin location;
calculating a shipment correspondence probability for each one or more vehicles of the set of vehicles based on divergence of a travelled route of a respective vehicle of the one or more vehicles from the optimal route;
determining a shipment vehicle of the one or more vehicles based on the calculated shipment correspondence probability; and
providing a notification corresponding to tracking information associated with the shipment vehicle, via a tracking application.

17. The method of claim 16, further comprising:
updating shipment information of the shipment with the tracking information associated with the shipment vehicle; and
providing the notification corresponding to the shipment information along with the tracking information via the tracking application.

18. The method of claim 16, comprising providing the notification corresponding to the tracking information associated with the shipment vehicle via the tracking application, based on a determination that the calculated shipment correspondence probability for the shipment vehicle is more than or equal to a threshold.

19. The method of claim 16, comprising providing the notification corresponding to the tracking information associated with the shipment vehicle via the tracking application, based on a determination that the calculated shipment correspondence probability for the shipment vehicle has a highest value amongst the calculated shipment correspondence probability for each of the one or more vehicles.

20. A non-transitory computer-readable storage medium carrying one or more sequences of one or more instructions which, when executed by one or more processors, cause an apparatus to perform operations comprising:
obtaining an optimal route between an origin location and a destination location of the shipment, wherein the optimal route is obtained when the shipment is present at the origin location;
periodically receiving a list of anonymized vehicle identifiers (IDs) associated with a set of vehicles present in a predefined area of the origin location of the shipment, wherein the list of the anonymized vehicle IDs is received based on a time window of departure of the shipment from the origin location;
calculating a shipment correspondence probability for each one or more vehicles of the set of vehicles based on divergence of a travelled route of a respective vehicle of the one or more vehicles from the optimal route;
determining a shipment vehicle of the one or more vehicles based on the calculated shipment correspondence probability; and
providing a notification corresponding to tracking information associated with the shipment vehicle, via a tracking application.
